(19) United States
(12) Patent Application Publication
(10) Pub. No.: US 2026/0261698 A1
(43) Pub. Date: Sep. 3, 2026

(54) METHOD AND APPARATUS FOR DECODING AND ENCODING DATA

(71) Applicant: HUAWEI TECHNOLOGIES CO., LTD., Shenzhen (CN)

(72) Inventors: Panqi Jia, Shenzhen (CN); Timofey Mikhailovich Solovyev, Munich (DE); Ze Cui, Beijing (CN); Jue Mao, Hangzhou (CN); Tiansheng Guo, Munich (DE); Yi Ma, Beijing (CN); Ahmet Burakhan Koyuncu, Munich (DE); Alexander Alexandrovich Karabutov, Munich (DE); Yin Zhao, Hangzhou (CN); Jing Wang, Beijing (CN); Elena Alexandrovna Alshina, Munich (DE)

(73) Assignee: HUAWEI TECHNOLOGIES CO., LTD., Shenzhen (CN)

(21) Appl. No.: 19/656,495

(22) Filed: Apr. 23, 2026

Related U.S. Application Data
(63) Continuation of application No. PCT/EP2024/071650, filed on Jul. 31, 2024.

(30) Foreign Application Priority Data
Oct. 23, 2023 (WO) PCT/CN2023/126009

(51) Int. Cl. H04N 19/44; G06T 9/00; H04N 19/124; H04N 19/149

(52) U.S. Cl. CPC H04N 19/44; G06T 9/002; H04N 19/124; H04N 19/149

(57) ABSTRACT

The present disclosure provides an improved decoding method to ensure consistent quality of decoded images. The decoding method, which is suitable for decoding pictures or a video from a bitstream, includes obtaining, from the bitstream, a rate control parameter indicating a compression ratio, and obtaining an asymmetric interval defined by upper and lower rate control thresholds. If the value of the rate control parameter lies outside of the range of the asymmetric interval, the decoding method further comprises clipping the rate control parameter to obtain a clipped rate control parameter.

### CROSS-REFERENCE TO RELATED APPLICATIONS

This application is a continuation of International Application No. PCT/EP2024/071650, filed on Jul. 31, 2024, which claims priority to International Patent Application No. PCT/CN2023/126009, filed on Oct. 23, 2023. The disclosures of the aforementioned applications are hereby incorporated by reference in their entireties.

### TECHNICAL FIELD

Embodiments of the present disclosure generally relate to the field of decoding and encoding data based on a neural network architecture. In particular, some embodiments relate to methods and apparatuses for such decoding and encoding images and/or videos from a bitstream using a plurality of processing layers.

### BACKGROUND

Hybrid image and video codecs have been used for decades to compress image and video data. In such codecs, signal is typically encoded block-wisely by predicting a block and by further coding only the difference between the original bock and its prediction. In particular, such coding may include transformation, quantization and generating the bitstream, usually including some entropy coding. Typically, the three components of hybrid coding methods—transformation, quantization, and entropy coding—are separately optimized. Modern video compression standards like High-Efficiency Video Coding (HEVC), Versatile Video Coding (VVC) and Essential Video Coding (EVC) also use transformed representation to code residual signal after prediction.

Recently, neural network architectures have been applied to image and/or video coding. In general, these neural network (NN) based approaches can be applied in various different ways to the image and video coding. For example, some end-to-end optimized image or video coding frameworks have been discussed. Moreover, deep learning has been used to determine or optimize some parts of the end-to-end coding framework such as selection or compression of prediction parameters or the like. Besides, some neural network based approaches have also been discussed for usage in hybrid image and video coding frameworks, e.g. for implementation as a trained deep learning model for intra or inter prediction in image or video coding. The end-to-end optimized image or video coding applications discussed above have in common that they produce some feature map data, which is to be conveyed between encoder and decoder.

Neural networks are machine learning models that employ one or more layers of nonlinear units based on which they can predict an output for a received input. Some neural networks include one or more hidden layers in addition to an output layer. A corresponding feature map may be provided as an output of each hidden layer. Such corresponding feature map of each hidden layer may be used as an input to a subsequent layer in the network, i.e., a subsequent hidden layer or the output layer. Each layer of the network generates an output from a received input in accordance with current values of a respective set of parameters. In a neural network that is split between devices, e.g. between encoder and decoder, a device and a cloud or between different devices, a feature map at the output of the place of splitting (e.g. a first device) is compressed and transmitted to the remaining layers of the neural network (e.g. to a second device).

Further improvement of encoding and decoding using trained network architectures may be desirable.

### SUMMARY

The present disclosure provides methods and apparatuses to improve the quality of methods of decoding encoded image data and to improve efficiency in methods of encoding data, in particular to improve methods of performing bit rate matching.

According to a first aspect, the present disclosure relates to a method for decoding for picture or video processing from a bitstream, the method comprising: obtaining, from the bitstream, a rate control parameter having been used to encode the data for picture or video by an encoder model, wherein the rate control parameter indicates a compression ratio; obtaining an asymmetric interval defined by an upper rate control threshold and a lower rate control threshold, and determining whether a value of the rate control parameter lies outside of a range of the asymmetric interval. If the value of the rate control parameter lies outside of the range of the asymmetric interval, the method further comprises clipping the rate control parameter to obtain a clipped rate control parameter, the clipping comprising: if the value of the rate control parameter is greater than the upper rate control threshold, setting the clipped rate control parameter equal to the upper rate control threshold; and if the value of the rate control parameter is smaller than the lower rate control threshold, setting the clipped rate control parameter equal to the lower rate control threshold, wherein an asymmetry of the asymmetric interval is characterised in that a first magnitude defined by a difference between a largest representable value of the rate control parameter and the upper rate control threshold is greater than a second magnitude defined by a difference between a smallest representable value of the rate control parameter and the lower rate control threshold.

Such a decoding method helps to ensure the quality of the decoded image data by ensuring that the quality of the encoded data is maintained in the output. Specifically, this method has the advantage of avoiding a rate control parameter of too high a value, which, in examples, has the potential to wastefully increase the number of bits used to signal the control rate parameter without providing a corresponding bitrate gain. Moreover, this method has the advantage of avoiding a rate control parameter of too small a value, which has the potential to inadvertently provide a decoded output of poorer quality (e.g., having a lower bitrate) than anticipated. The advantage of the asymmetry of the interval is that it accounts for the surprising phenomenon in which the performance of the decoder deviates more rapidly from a desired performance envelope for higher rate control parameters, and deviates away from said envelope to a much lesser degree for smaller rate control parameters.

The foregoing and other embodiments can each optionally include one or more of the following features, alone or in combination.

In a possible implementation, the rate control parameter defines a quantization step for a latent space encoded in the bitstream. Since the degree of quantization of the latent space has been selected already by the encoder, a surprising advantage of embodiments of the present disclosure is that the quantized latent space can be unquantized using a different control rate parameter. In some cases, exactly the same quality of output can be obtained using a control rate parameter that requires fewer bits (e.g., in the case where the value of the rate control parameter is greater than the upper rate control threshold).

In a possible implementation, each of the upper rate control threshold and the lower rate control threshold are pre-determined in dependence on a deviation tolerance, wherein the deviation tolerance is defined, for each of the upper and lower rate control thresholds, by a numerical deviation between i) a model performance envelope defined by a model used to train the encoder model and ii) an encoder performance obtained as a result of encoding the data using each respective upper rate control threshold and the lower rate control threshold.

Since higher (for example, positive) values deviate faster from a desired model performance envelope than smaller (e.g., negative) values of the rate control parameter, an asymmetric clipping interval can be pre-determined. Advantageously, the fact that the asymmetry is derived from the relative deviation from a model performance envelope, irrespective of the of the rate control parameter chosen, the decoder will produce consistent and predictable quality results. This is in contrast to known systems in which larger values of control rate parameters (e.g., close to the largest representable value) could result in a performance that deviated drastically from the model performance envelope, compared to smaller values of control rate parameters (e.g., close to the smallest representable value) in which the deviation from the model performance envelope was small, or even negligible. In a possible implementation, the numerical deviation is calculated in dependence on a difference from i) a target bitrate value, and ii) a target compression quality value, of the model performance envelope.

In a possible implementation, the rate control parameter defines a ratio between i) a compression quantization parameter selected by the encoder model and ii) a training compression quantization parameter used to train a compression model used by the encoder model.

In a possible implementation a bit-depth of the rate control parameter is n, the largest representable value of the rate control parameter being 2ⁿ⁻¹−1, and the smallest representable value of the rate control parameter being −2ⁿ⁻¹, wherein the asymmetry of the asymmetric interval is characterised in that a magnitude of the lower rate control threshold is greater than a magnitude of the upper rate control threshold. This representation is a bit-efficient way of representing the rate control parameter, e.g., because a bit-depth of n may represent the entire range of values. For example, in one possible implementation, the bit-depth of the rate control parameter is n=12, and the asymmetric interval is [−1069, 702].

In a possible implementation, a bit-depth of the rate control parameter is n, the largest representable value of the rate control parameter being 2ⁿ−1, and the smallest representable value of the rate control parameter being 0, the method comprising prior to determining whether a value of the rate control parameter lies outside of a range of the asymmetric interval: shifting the rate control parameter by an offset, wherein a magnitude of the offset is greater than 2ⁿ⁻¹, wherein the upper rate control threshold is defined by 2ⁿ−1-offset, and the lower rate control threshold is defined by 0-offset. In one possible implementation, n<17. In another possible implementation, n<13. Preferably, n<11.

This implementation, where the representable range is [0, 2ⁿ−1] has two advantages. In a first respect, the rate control parameter can be signalled using at least one fewer bit, i.e., because the offset itself produces the upper and lower rate control threshold. Furthermore, in some embodiments, this method allows that the clipping of the rate control parameters is intrinsically performed by the offset. For example, in some cases, the lower rate control threshold defined by 0-offset may, in effect, be equal to the lowest representable value of the rate control parameter.

In a possible implementation, the method may comprise further reducing the value of the upper rate control threshold, defined by 2ⁿ−1-offset, in order to increase a bias of the asymmetric interval towards the negative portion of the asymmetric interval. For example, a control rate parameter equal to 2ⁿ−1-offset may, in some cases, deviate too far from the model performance envelope, therefore the upper rate control threshold may be obtained by further reducing the value of 2ⁿ−1-offset to ensure good performance across the performance envelope.

In a possible implementation the encoder model is a neural network-based image codec having a variable rate, wherein the rate control parameter is a continuously variable parameter. This provides the benefit that an arbitrary rate control parameter can be used to provide an arbitrary bitrate output, within the permissible output of the compression model.

In a possible implementation, the clipped rate control parameter is used to define a set of data defining a gain to be applied to a latent representation of encoded data. For example, the clipped rate control parameter is used as a scaling factor for gain data, such as an inverse gain tensor, where the gain data is applied to the quantized latent space to form unquantized latent space which may then be formed into the image data.

In a possible implementation decoding the data for picture or video processing from the bitstream comprises performing the steps of the first aspect a second time for a respective second rate control parameter and a second asymmetric interval, wherein the respective first rate control parameter and second rate control parameter correspond to two separable components representing the data for the picture or video. Advantageously, this has the benefit that the rate control parameter can be clipped for each separate component. Moreover, the asymmetric interval may be pre-determined for each of the components, such that a first asymmetric interval is used to clip the first rate control parameter, and a second asymmetric interval is used to clip the second rate control parameter. As an example, the first and second components may correspond to the separated luma and chroma channels of image data.

In a possible implementation the rate control parameter is defined in a logarithmic domain. This has the advantage of allowing an effectively wider range of rate control parameters to be encoded in the bitstream than if the rate control parameter were defined in a linear domain. In some examples, the rate control parameter may represent a logarithm of a ratio, where the ratio is between i) a compression quantization parameter selected by the encoder model and ii) a training compression quantization parameter used to train a compression model used by the encoder model.

According to a second aspect, the present disclosure relates to a device for decoding data for picture or video processing from a bitstream, the device comprising: an obtaining unit configured to obtain: from the bitstream, a rate control parameter having been used to encode the data for picture or video data by an encoder model, wherein the rate control parameter indicates a compression ratio; and an asymmetric interval defined by an upper rate control threshold and a lower rate control threshold. The device further comprises a clipping unit configured to: determine whether a value of the rate control parameter lies outside of a range of the asymmetric interval; and in response to determining that the value of the rate control parameter lies outside of the range of the asymmetric interval, clip the rate control parameter to obtain a clipped rate control parameter, the clipping comprising: if the value of the rate control parameter is greater than the upper rate control threshold, setting the clipped rate control parameter equal to the upper rate control threshold; and if the value of the rate control parameter is smaller than the lower rate control threshold, setting the clipped rate control parameter equal to the lower rate control threshold, wherein an asymmetry of the asymmetric interval is characterised in that a first magnitude defined by i) a difference between a largest representable value of the rate control parameter and the upper rate control threshold is greater than a second magnitude defined by ii) a difference between a smallest representable value of the rate control parameter and the lower rate control threshold.

The method according to the first aspect of the present disclosure may be performed by the device according to the second aspect of the present disclosure. Further features and implementations of the method according to the first aspect of the present disclosure correspond to respective features and implementations of the device according to the second aspect of the present disclosure. The advantages of the method according to the first aspect can be the same as those for the corresponding implementation of the device according to the second aspect.

According to a third aspect, the present disclosure relates to a method for encoding data for picture or video processing to obtain a bitstream, the method comprising: obtaining image data defining at least a portion of an image; obtaining a plurality of compression models, each respective compression model defined by a respective default rate control parameter having been used to train the compression model; and obtaining a target bitrate indicating a degree of compression. The method further comprises selecting a first compression model, from the plurality of compression models, in dependence on the target bitrate; subsequent to selecting the first compression model: encoding the image data, using an encoder, in dependence on the selected first compression model to thereby obtain a latent representation of the image data; searching for a rate control parameter, the searching comprising: determining a trial rate control parameter, wherein the trial rate control parameter indicates a compression ratio; evaluating a suitability of the trial rate control parameter comprising calculating a trial bitrate in dependence on the latent representation and the trial rate control parameter; and obtaining a bitstream in dependence on the latent representation and a rate control parameter selected in dependence on the evaluating.

This third aspect confers the advantage of allowing the separation of i) selecting the compression model and ii) performing the search for the rate control parameter. Separating these two steps of the encoding procedure can confer a significant speedup of the encoding process, because it enables the rate control parameter to be searched in respect of only one compression model. In previously known methods, these two parts of the encoding could not be separated, and as a result the method of encoding took substantially longer.

The foregoing and other embodiments can each optionally include one or more of the following features, alone or in combination.

In a possible implementation, evaluating the suitability of the trial rate control parameter comprises: quantizing the latent representation in dependence on the trial rate control parameter; determining the trial bitrate in dependence on the quantized latent representation; determining that the trial bitrate is within a tolerance threshold to the target bitrate; and obtaining the bitstream in dependence on quantized latent representation. Advantageously, this evaluation does not require a decoding codec to be run, because the suitability of the rate control parameter can be determined based on the resulting bitrate (for example bits per pixel, or bpp). This, this method obviates the need to calculate an objective loss, which would in turn require a computationally expensive decoding codec to be run.

In a possible implementation, the method comprises determining the trial rate control parameter in dependence on the target bitrate. In other words, the target bitrate may be used to direct a search, or may be used to help approximate, a good starting point for a trial rate control parameter, i.e., that it likely to be able to produce the target bitrate. In prior art methods, the search was typically unguided, as it relied on an iterative search, such as a binary search.

In a possible implementation determining the trial rate control parameter comprises: determining a mathematical relationship between an input variable of the selected first compression model, the input variable indicative of a compression ratio, and an output of the selected first compression model, the output indicating a bitrate; calculating the trial rate control parameter in dependence on determining an input corresponding to the target bitrate using the mathematical relationship. This has the advantage that a suitable control rate parameter can be derived very quickly, and potentially immediately, i.e., by using the linear relationship to directly determine a control parameter that will produce the target bitrate (once used to quantize the latent space).

In a possible implementation the mathematical relationship is a linear relationship. A linear relationship is particularly effective as it is efficient to use to find a corresponding trial rate control parameter from a target bitrate.

In a possible implementation, the input variable and the output of the selected first compression model are defined in a logarithmic domain. This can help the linearity of the relationship; in other words, when defined in the logarithmic domain, the mathematical relationship better fits a linear relationship.

In a possible implementation, selecting the first compression model comprises, for each compression model: calculating a bitrate associated with the default rate control parameter having been used to train the compression mode; determining a relative bit distance between the calculated bitrate and the bitrate; and selecting the first compression model in dependence on at least one respective relative bit distance for at least one compression model.

This has the advantage that the compression model is selected based one value, i.e., the default rate control parameter, for each compression model. In some prior art methods, all compression models whose minimum and maximum rate control parameters produced bitrates that encompassed the target bitrate were chosen as candidates this has the disadvantage that, for each of the maximum and minimum rate control parameters, a bitrate was calculated. By contrast, in the present method, only one bitrate (corresponding to the default rate control parameter) need be calculated/determined. Consequently, the present method for selecting a compression model can be at least twice as efficient.

In a possible implementation, selecting the first compression model comprises selecting a compression model having the smallest relative bit distance between its respective calculated bitrate and the target bitrate. This also has the advantage that exactly one compression model is chosen as a candidate for which to use to search for a control rate parameter. In known systems, multiple compression models were chosen.

In a possible implementation, the first compression model is selected only in dependence on the target bitrate. As mentioned, this has the advantage that only one parameter, as opposed to two parameters (each of the maximum and minimum rate control parameters) are needed to select a compression model.

In a possible implementation, selecting the compression model comprises: determining that a value of the target bitrate lies between a bitrate associated with the first compression model and a second bitrate associated with a second compression model, and subsequent to said determining, encoding the image data, using the encoder, in dependence on the second compression model to thereby obtain a second latent representation. The method may further comprise searching for a second rate control parameter, the searching comprising: determining a second trial rate control parameter; evaluating the second trial rate control parameter comprising calculating a second trial bitrate in dependence on the second latent representation and the second trial rate control parameter; decoding the first and second latent representation in dependence on the respective first and second rate control parameter, to thereby obtain a respective first and second decoded image data; for each of the respective first and second decoded image data, determining a respective objective loss in dependence on the image data defining at least a portion of an image; and selecting from the first or second compression model in dependence on the respective objective loss function.

This implementation has the advantage that it can select a more appropriate compression model based on a determine objective loss. For example, it may be advantageous to use this implementation when the target bpp bitrate lies equidistant between the default bitrate for two compression models (e.g., where the relative bit distance between the default bpp and the target bpp for two compression models is equal or substantially equal).

In a possible implementation, the selected first compression model is selected without re-calculating the latent representation of the image data subsequent to the searching for the rate control parameter. This has the clear advantage that the latent representation needs to be calculated exactly once, and may then be re-used.

In a possible implementation, searching for the rate control parameter comprises determining a trial rate control parameter in dependence on an interval defined by an upper rate control threshold and a lower rate control threshold. In a possible implementation, the interval is asymmetric, and wherein an asymmetry of the asymmetric interval is characterised in that a first magnitude defined by a difference between a largest representable value of the trial rate control parameter and the upper rate control threshold is greater than a second magnitude defined by a difference between a smallest representable value of the trial rate control parameter and the lower rate control threshold. Providing an interval provides the advantage that the search can be sped up, i.e., because a smaller range of rate control parameters need be searched.

In a possible implementation, encoding data for picture or video processing to obtain a bitstream comprises performing the steps of the third aspect for a second time, for a respective second plurality of compression models and a respective second target bitrate, wherein the performance of the steps of third aspect twice corresponds to encoding data associated with separable components of an image represented by the image data.

According to a fourth aspect, the present disclosure relates to a device for encoding data for picture or video processing to obtain a bitstream, the device comprising: an obtaining unit configured to obtain: image data defining at least a portion of an image; a plurality of compression models, each respective compression model defined by a respective default rate control parameter having been used to train the compression model; a target bitrate indicating a degree of compression. The device further comprises an encoding unit configured to: select a first compression model, from the plurality of compression models, in dependence on the target bitrate; subsequent to selecting the first compression model: encode the image data, using an encoder, in dependence on the selected first compression model to thereby obtain a latent representation of the image data; search for a rate control parameter, the searching comprising: determining a trial rate control parameter, wherein the trial rate control parameter indicates a compression ratio; evaluating a suitability of the trial rate control parameter comprising calculating a trial bitrate in dependence on the latent representation and the trial rate control parameter; and obtain a bitstream in dependence on the latent representation and a rate control parameter selected in dependence on the evaluating.

Such a device for encoding may refer to the same advantageous effect as the method for encoding according to the third aspect. Details are not described herein again. The encoding device provides technical means for implementing an action in the method defined according to the third aspect. Further features and implementations of the third aspect of the present disclosure correspond to respective features and implementations of the device according to the fourth aspect of the present disclosure. The advantages of the method according to the third aspect can be the same as those for the corresponding implementation of the device according to the fourth aspect. The function may be implemented by hardware, or may be implemented by hardware executing corresponding software.

According to a fifth aspect, the present disclosure relates to an apparatus for encoding data for picture or video processing to obtain a bitstream, the method comprising: obtaining a plurality of compression models, each respective compression model defined by a respective default rate control parameter having been used to train the compression model; obtaining image data defining at least a portion of an image; obtaining a target bitrate indicating a degree of compression; for each compression model: calculating a bitrate associated with the default rate control parameter having been used to train the compression mode; determining a relative bit distance between the calculated bitrate and the target bitrate; selecting a first compression model in dependence on at least one respective relative bit distance for at least one of the compression model; and using the first compression model to obtain the bitstream from the image data.

This method confers the advantage wherein selecting the compression model is determined based only on the relative bit distance, and need not involve calculating a loss, or using the decoder. Moreover, the relative bit distance depends on only the bitrate associated with the default bit rate. In some prior art methods, all compression models whose minimum and maximum rate control parameters produced bitrates that encompassed the target bitrate were chosen as candidates this has the disadvantage that, for each of the maximum and minimum rate control parameters, a bitrate was calculated. By contrast, in the present method, only one bitrate (corresponding to the default rate control parameter) need be calculated/determined to find the relative bit distance. Consequently, the present method for selecting a compression model can be at least twice as efficient.

The foregoing and other embodiments can each optionally include one or more of the following features, alone or in combination.

In a possible implementation, selecting the first compression model comprises selecting a compression model having the smallest relative bit distance between its respective calculated bitrate and the target bitrate.

In a possible implementation, the method comprises, subsequent to selecting the first compression model: encoding the image data, using an encoder, in dependence on the selected first compression model to thereby obtain a latent representation of the image data; searching for a rate control parameter, the searching comprising: determining a trial rate control parameter, wherein the trial rate control parameter indicates a compression ratio; evaluating a suitability of the trial rate control parameter comprising calculating a trial bitrate in dependence on the latent representation and the trial rate control parameter; and obtaining the bitstream in dependence on the latent representation and a rate control parameter selected in dependence on the trial rate control parameter.

In a possible implementation, determining the trial rate control parameter comprises: determining a mathematical relationship between an input variable of the selected first compression model, the input variable indicative of a compression ratio, and an output of the selected first compression model, the output indicating a bitrate; calculating the trial rate control parameter in dependence on determining an input corresponding to the target bitrate using the mathematical relationship. The mathematical relationship is a linear relationship. This has the advantage that a suitable control rate parameter can be derived very quickly, and potentially immediately, i.e., by using the linear relationship to directly determine a control parameter that will produce the target bitrate (once used to quantize the latent space). A linear relationship is particularly effective as it is efficient to use to find a corresponding trial rate control parameter from a target bitrate.

In a possible implementation, the input variable and the output of the selected first compression model are defined in a logarithmic domain. This can help the linearity of the relationship; in other words, when defined in the logarithmic domain, the mathematical relationship better fits a linear relationship.

In a possible implementation, selecting the compression model comprises: determining that a value of the target bitrate lies between a bitrate associated with a first compression model and a second bitrate associated with a second compression model, and subsequent to said determining: encoding the image data, using an encoder, in dependence on the second compression model to thereby obtain a second latent representation; searching for a second rate control parameter, the searching comprising: determining a second trial rate control parameter; evaluating the second trial rate control parameter comprising calculating a second trial bitrate in dependence on the second latent representation and the second trial rate control parameter; decoding the first and second latent representation in dependence on the respective first and second rate control parameter, to thereby obtain a respective first and second decoded image data; for each of the respective first and second decoded image data, determining a respective objective loss in dependence on the image data defining at least a portion of an image; and selecting from the first or second compression model in dependence on the respective objective loss function.

This implementation has the advantage that it can select a more appropriate compression model based on a determine objective loss. For example, it may be advantageous to use this implementation when the target bpp bitrate lies equidistant between the default bitrate for two compression models (e.g., where the relative bit distance between the default bpp and the target bpp for two compression models is equal or substantially equal).

In a possible implementation, selecting the compression model is performed without decoding the bitstream obtained from the image data to calculate an objective loss. This has the significant advantage of obviating the need to run a decoder, which is computationally expensive. Instead, the selection of the compression model requires only that, once chosen, the bitrate produced by the compression model and the selected/determined rate control parameter is within a tolerance of the target bitrate.

According to a sixth aspect, there is provided a device for encoding data for picture or video processing to obtain a bitstream, the device comprising: an obtaining unit configured to obtain: a plurality of compression models, each respective compression model defined by a respective default rate control parameter having been used to train the compression model; image data defining at least a portion of an image; a target bitrate indicating a degree of compression; an encoder unit configured to, for each compression model: calculate a bitrate associated with the default rate control parameter having been used to train the compression mode; determine a relative bit distance between the calculated bitrate and the target bitrate; select a first compression model in dependence on at least one respective relative bit distance for at least one of the compression model; and use the first compression model to obtain the bitstream from the image data.

The method according to the fifth aspect of the present disclosure may be performed by the device according to the sixth aspect of the present disclosure. Further features and implementations of the method according to the fifth aspect of the present disclosure correspond to respective features and implementations of the device according to the sixth aspect of the present disclosure. The advantages of the method according to the fifth aspect can be the same as those for the corresponding implementation of the device according to the sixth aspect.

According to a seventh aspect, the present disclosure relates to a method for encoding data for picture or video processing to obtain a bitstream, the method comprising: obtaining and storing a latent representation of image data defining at least a portion of an image, the latent representation having been produced in dependence on the image data and a compression model; obtaining a target bitrate indicating a degree of compression; subsequent to obtaining the latent representation, searching for a rate control parameter to define a compression ratio, the searching comprising: determining a trial rate control parameter in dependence on the target bitrate; evaluating a suitability of the trial rate control parameter comprising calculating a trial bitrate in dependence on the stored latent representation and the trial rate control parameter; obtaining a bitstream in dependence on the latent representation and the rate control parameter.

Generally, this seventh aspect confers the advantage that the rate control parameter can be determined without needing to re-calculate the latent representation, and without needing to run a decoder. In other words, once the compression model is obtained, the only further variable required to be searched to perform the encoding is the rate control parameter. Advantageously, this means that the particular compression model and the latent tensor can be obtained entirely separately from searching for the particular compression model.

In a possible implementation, searching for the rate control parameter is performed without re-calculating the latent representation. As mentioned, this has the advantage that the latent representation needs to be calculated exactly once, and may then be stored and re-used as needed.

In a possible implementation searching for the rate control parameter is performed without decoding the bitstream to obtain a decoded image obtained from the image data to calculate an objective loss between the decoded image and the image data defining at least a portion of an image. Calculating an objective loss is computationally very expensive, not only because the loss functions themselves are intensive, but because the decoder needs to be run in order to calculate the loss. Therefore, it is a significant advantage of the present implementation that the need to calculate an objective loss is obviated.

In a possible implementation, determining the trial rate control parameter in dependence on the target bitrate comprises: determining a mathematical relationship between an input variable of the compression model, the input variable indicative of a compression ratio, and an output of the compression model, the output indicating a bitrate; and calculating the trial rate control parameter in dependence on determining an input required to obtain the target bitrate using the mathematical relationship.

In a possible implementation, evaluating a suitability of the trial rate control parameter comprises: quantizing the latent representation in dependence on the trial rate control parameter; determining the trial bitrate in dependence on the quantized latent representation; and determining that the trial bitrate is within a tolerance threshold to the target bitrate, thereby setting the rate control parameter equal to the trial rate control parameter.

In a possible implementation the mathematical relationship is a linear mathematical relationship, and wherein searching for the rate control parameter comprises: quantizing the latent representation in dependence on the trial rate control parameter; determining the trial bitrate in dependence on the quantized latent representation; determining that the trial bitrate is not within a tolerance threshold to the target bitrate; adjusting a gradient of the linear relationship to thereby obtain a reformulated linear relationship defined in dependence on the trial bitrate; calculating a secondary trial rate control parameter in dependence on determining an input required to obtain the target bitrate using the reformulated linear relationship; quantizing the latent representation in dependence on the secondary trial rate control parameter to thereby determine a secondary trial bitrate; determining that the secondary trial bitrate is within a tolerance threshold to the target bitrate, thereby setting the rate control parameter equal to the secondary trial rate control parameter.

Advantageously, if the linear relationship does not provide a control rate parameter capable of producing a sufficiently good bitrate output in the first instance, the trial bitrate that is produced by the first trial rate control parameter can be re-used to reformulate the linear relationship. The reformulated linear relationship, beneficially, is more likely to be able to predict a secondary trial rate control parameter value that will produce a bitrate (bpp) that is within a tolerance to the target bitrate.

In a possible implementation, calculating a trial bitrate in dependence on the stored latent representation and the trial rate control parameter comprises applying a gain vector to the stored latent representation, the gain vector being scaled by the trial rate control parameter.

According to an eighth aspect, there is provided a device for encoding data for picture or video processing to obtain a bitstream, the device comprising: an obtaining unit configured to: obtain and store a latent representation of image data defining at least a portion of an image, the latent representation having been produced in dependence on the image data and a compression model; obtain a target bitrate indicating a degree of compression. The device further comprises an encoder unit configured to: subsequent to obtaining the latent representation, search for a rate control parameter to define a compression ratio, the searching comprising: determine a trial rate control parameter in dependence on the target bitrate; and evaluate a suitability of the trial rate control parameter comprising calculating a trial bitrate in dependence on the stored latent representation and the trial rate control parameter; obtain a bitstream in dependence on the latent representation and the rate control parameter.

In accordance with any of preceding aspects, the bitrate may defines an effective number of bits per pixel. In accordance with any of preceding aspects, the encoder or encoder model may comprise a neural network.

According to a ninth aspect, a computer-readable storage medium having stored thereon instructions that when executed cause one or more processors to encode video data is proposed. The instructions cause the one or more processors to perform the method according to the first or second aspect or any possible embodiment of the first, third, fifth, or seventh aspect.

According to a tenth aspect, there is provided a computer program stored on a non-transitory medium and including code instructions, which, when executed on one or more processor, causes the one or more processor to execute the method according to any possible embodiment of the first, third, fifth, or seventh aspect.

Details of one or more embodiments are set forth in the accompanying drawings and the description below. Other features, objects, and advantages will be apparent from the description, drawings, and claims.

### BRIEF DESCRIPTION OF THE DRAWINGS

In the following embodiments of the present disclosure are described in more detail with reference to the attached figures and drawings, in which:

FIG. 1 is a schematic drawing illustrating channels processed by layers of a neural network;

FIG. 2 is a schematic drawing illustrating an autoencoder type of a neural network;

FIG. 3A is a schematic drawing illustrating an exemplary network architecture for encoder and decoder side including a hyperprior model;

FIG. 3B is a schematic drawing illustrating a general network architecture for encoder side including a hyperprior model;

FIG. 3C is a schematic drawing illustrating a general network architecture for decoder side including a hyperprior model;

FIG. 4 is a schematic drawing illustrating an exemplary network architecture for encoder and decoder side including a hyperprior model;

FIG. 5 is a block diagram illustrating a structure of a cloud-based solution for machine based tasks such as machine vision tasks;

FIG. 6A is a block diagram illustrating end-to-end video compression framework based on a neural networks;

FIG. 6B is a block diagram illustrating some exemplary details of application of a neural network for motion field compression;

FIG. 6C is a block diagram illustrating some exemplary details of application of a neural network for motion compensation;

FIG. 7 is a block diagram illustrating an example of an encoding apparatus and a decoding apparatus;

FIG. 8 is a block diagram illustrating another example of an encoding apparatus and a decoding apparatus;

FIG. 9 is a graph indicating a plurality of compression models used for encoding and decoding in embodiments of the present disclosure;

FIG. 10 is a flow diagram illustrating an exemplary method for decoding data such as bitstream data used in decoding of image or video data;

FIG. 11 shows a device for decoding for processing by a neural network based unit;

FIG. 12A is a schematic drawing illustrating a first method for selecting a compression model according to embodiments of the present disclosure;

FIG. 12B is a schematic drawing illustrating a second method for selecting a compression model according to embodiments of the present disclosure;

FIG. 13 is a graph indicating an approximate relation between a rate control parameter and a bitrate for a compression model according to embodiments of the present disclosure;

FIG. 14 is a schematic drawing illustrating a method for searching for and evaluating a rate control parameter for a given compression model according to embodiments of the present disclosure;

FIG. 15A is a flow diagram illustrating a first exemplary method for encoding data such as image or video data or a component thereof;

FIG. 15B is a flow diagram illustrating a second exemplary method for encoding data such as image or video data or a component thereof;

FIG. 15C is a flow diagram illustrating a third exemplary method for encoding data such as image or video data or a component thereof;

FIG. 16A shows a device for encoding for processing by a neural network based unit according to the first exemplary method for encoding data;

FIG. 16B shows a device for encoding for processing by a neural network based unit according to the second exemplary method for encoding data;

FIG. 16C shows a device for encoding for processing by a neural network based unit according to the third exemplary method for encoding data;

FIG. 17 shows a bitstream structure according to embodiments of the present disclosure;

FIG. 18 is a schematic drawing illustrating an embodiment network architecture for one component of an encoder side including a hyperprior model;

FIG. 19 is a schematic drawing illustrating an embodiment network architecture for one component of a decoder side including a hyperprior model;

FIG. 20 is a block diagram showing an example of a video coding system configured to implement embodiments of the present disclosure;

FIG. 21 is a block diagram showing another example of a video coding system configured to implement embodiments of the present disclosure;

FIG. 22 is a block diagram illustrating an example of an encoding apparatus or a decoding apparatus;

FIG. 23 is a block diagram illustrating another example of an encoding apparatus or a decoding apparatus;

FIG. 24 is a block diagram illustrating another example of an encoding apparatus or a decoding apparatus.

Like reference numbers and designations in different drawings may indicate similar elements.

### DETAILED DESCRIPTION OF THE EMBODIMENTS

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

In the following, an overview over some of the used technical terms and framework within which the embodiments of the present disclosure may be employed is provided.

### Artificial Neural Networks

Artificial neural networks (ANN) or connectionist systems are computing systems vaguely inspired by the biological neural networks that constitute animal brains. Such systems “learn” to perform tasks by considering examples, generally without being programmed with task-specific rules. For example, in image recognition, they might learn to identify images that contain cats by analyzing example images that have been manually labelled as “cat” or “no cat” and using the results to identify cats in other images. They do this without any prior knowledge of cats, for example, that they have fur, tails, whiskers and cat-like faces. Instead, they automatically generate identifying characteristics from the examples that they process.

An ANN Is based on a collection of connected units or nodes called artificial neurons, which loosely model the neurons in a biological brain. Each connection, like the synapses in a biological brain, can transmit a signal to other neurons. An artificial neuron that receives a signal then processes it and can signal neurons connected to it.

In ANN implementations, the “signal” at a connection is a real number, and the output of each neuron is computed by some non-linear function of the sum of its inputs. The connections are called edges. Neurons and edges typically have a weight that adjusts as learning proceeds. The weight increases or decreases the strength of the signal at a connection. Neurons may have a threshold such that a signal is sent only if the aggregate signal crosses that threshold. Typically, neurons are aggregated into layers. Different layers may perform different transformations on their inputs. Signals travel from the first layer (the input layer), to the last layer (the output layer), possibly after traversing the layers multiple times.

The original goal of the ANN approach was to solve problems in the same way that a human brain would. Over time, attention moved to performing specific tasks, leading to deviations from biology. ANNs have been used on a variety of tasks, including computer vision, speech recognition, machine translation, social network filtering, playing board and video games, medical diagnosis, and even in activities that have traditionally been considered as reserved to humans, like painting.

The name “convolutional neural network” (CNN) indicates that the network employs a mathematical operation called convolution. Convolution is a specialized kind of linear operation. Convolutional networks are neural networks that use convolution in place of a general matrix multiplication in at least one of their layers.

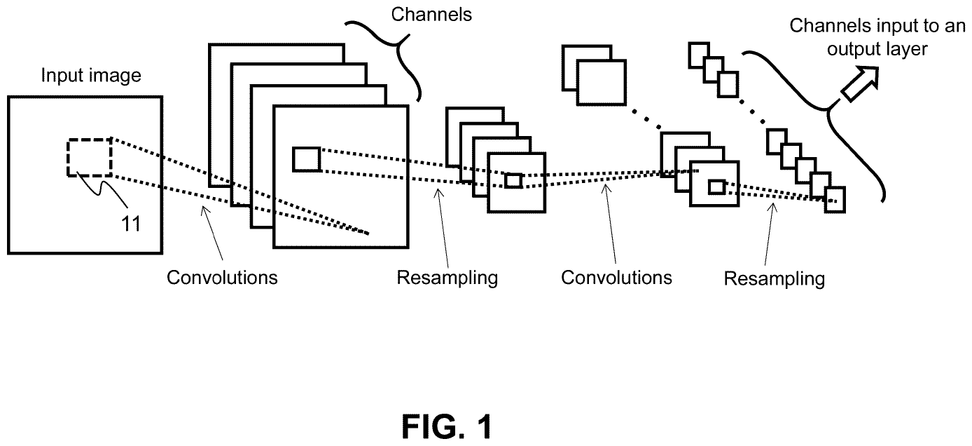

FIG. 1 schematically illustrates a general concept of processing by a neural network such as the CNN. A convolutional neural network consists of an input and an output layer, as well as multiple hidden layers. Input layer is the layer to which the input (such as a portion 11 of an input image as shown in FIG. 1) is provided for processing. The hidden layers of a CNN typically consist of a series of convolutional layers that convolve with a multiplication or other dot product. The result of a layer is one or more feature maps (illustrated by empty solid-line rectangles), sometimes also referred to as channels. There may be a resampling (such as subsampling) involved in some or all of the layers. As a consequence, the feature maps may become smaller, as illustrated in FIG. 1. It is noted that a convolution with a stride may also reduce the size (resample) an input feature map. The activation function in a CNN is usually a ReLU (Rectified Linear Unit) layer or Leaky ReLU, and is subsequently followed by additional convolutions such as pooling layers, fully connected layers and normalization layers, referred to as hidden layers because their inputs and outputs are masked by the activation function and final convolution. Though the layers are colloquially referred to as convolutions, this is only by convention. Mathematically, it is technically a sliding dot product or cross-correlation. This has significance for the indices in the matrix, in that it affects how the weight is determined at a specific index point.

When programming a CNN for processing images, as shown in FIG. 1, the input is a tensor with shape (number of images)×(image width)×(image height)×(image depth). It should be known that the image depth can be constituted by channels of an image. After passing through a convolutional layer, the image becomes abstracted to a feature map, with shape (number of images)×(feature map width)×(feature map height)×(feature map channels). A convolutional layer within a neural network should have the following attributes. Convolutional kernels defined by a width and height (hyper-parameters). The number of input channels and output channels (hyper-parameter). The depth of the convolution filter (the input channels) should be equal to the number channels (depth) of the input feature map.

In the past, traditional multilayer perceptron (MLP) models have been used for image recognition. However, due to the full connectivity between nodes, they suffered from high dimensionality, and did not scale well with higher resolution images. A 1000×1000-pixel image with RGB color channels has 3 million weights, which is too high to feasibly process efficiently at scale with full connectivity. Also, such network architecture does not take into account the spatial structure of data, treating input pixels which are far apart in the same way as pixels that are close together. This ignores locality of reference in image data, both computationally and semantically. Thus, full connectivity of neurons is wasteful for purposes such as image recognition that are dominated by spatially local input patterns.

Convolutional neural networks are biologically inspired variants of multilayer perceptrons that are specifically designed to emulate the behavior of a visual cortex. These models mitigate the challenges posed by the MLP architecture by exploiting the strong spatially local correlation present in natural images. The convolutional layer is the core building block of a CNN. The layer's parameters consist of a set of learnable filters (the above-mentioned kernels), which have a small receptive field, but extend through the full depth of the input volume. During the forward pass, each filter is convolved across the width and height of the input volume, computing the dot product between the entries of the filter and the input and producing a 2-dimensional activation map of that filter. As a result, the network learns filters that activate when it detects some specific type of feature at some spatial position in the input.

Stacking the activation maps for all filters along the depth dimension forms the full output volume of the convolution layer. Every entry in the output volume can thus also be interpreted as an output of a neuron that looks at a small region in the input and shares parameters with neurons in the same activation map. A feature map, or activation map, is the output activations for a given filter. Feature map and activation has same meaning. In some papers it is called an activation map because it is a mapping that corresponds to the activation of different parts of the image, and also a feature map because it is also a mapping of where a certain kind of feature is found in the image. A high activation means that a certain feature was found.

Another important concept of CNNs is pooling, which is a form of non-linear downsampling. There are several non-linear functions to implement pooling among which max pooling is the most common. It partitions the input image into a set of non-overlapping rectangles and, for each such sub-region, outputs the maximum.

Intuitively, the exact location of a feature is less important than its rough location relative to other features. This is the idea behind the use of pooling in convolutional neural networks. The pooling layer serves to progressively reduce the spatial size of the representation, to reduce the number of parameters, memory footprint and amount of computation in the network, and hence to also control overfitting. It is common to periodically insert a pooling layer between successive convolutional layers in a CNN architecture. The pooling operation provides another form of translation invariance.

The pooling layer operates independently on every depth slice of the input and resizes it spatially. The most common form is a pooling layer with filters of size 2×2 applied with a stride of 2 at every depth slice in the input by 2 along both width and height, discarding 75% of the activations. In this case, every max operation is over 4 numbers. The depth dimension remains unchanged. In addition to max pooling, pooling units can use other functions, such as average pooling or l2-norm pooling. Average pooling was often used historically but has recently fallen out of favour compared to max pooling, which often performs better in practice. Due to the aggressive reduction in the size of the representation, there is a recent trend towards using smaller filters or discarding pooling layers altogether. “Region of Interest” pooling (also known as ROI pooling) is a variant of max pooling, in which output size is fixed and input rectangle is a parameter. Pooling is an important component of convolutional neural networks for object detection based on Fast R-CNN architecture.

The above-mentioned ReLU is the abbreviation of rectified linear unit, which applies the non-saturating activation function. It effectively removes negative values from an activation map by setting them to zero. It increases the nonlinear properties of the decision function and of the overall network without affecting the receptive fields of the convolution layer. Other functions are also used to increase nonlinearity, for example the saturating hyperbolic tangent and the sigmoid function. ReLU is often preferred to other functions because it trains the neural network several times faster without a significant penalty to generalization accuracy.

Leaky Rectified Linear Unit, or Leaky ReLU, is a type of activation function based on a ReLU, but it has a small slope for negative values instead of a flat slope. The slope coefficient is determined before training, i.e. it is not learnt during training. This type of activation function is popular in tasks where it suffers from sparse gradients, for example training generative adversarial networks. Leaky ReLU applies the element-wise function: LeakyReLU(x)=max(0,x)+negative_slope*min(0,x), or

$$LeakyReLU ( x ) = \{ \begin{matrix}x , & if x \geq 0 \\ negative\_slope * x , & otherwise\end{matrix}$$

Among them, parameters:
negative_slope—Controls the angle of the negative slope. Default: 1e-2
inplace—can optionally do the operation in-place. Default: False.

After several convolutional and max pooling layers, the high-level reasoning in the neural network is done via fully connected layers. Neurons in a fully connected layer have connections to all activations in the previous layer, as seen in regular (non-convolutional) artificial neural networks. Their activations can thus be computed as an affine transformation, with matrix multiplication followed by a bias offset (vector addition of a learned or fixed bias term).

The “loss layer” (including calculating of a loss function) specifies how training penalizes the deviation between the predicted (output) and true labels and is normally the final layer of a neural network. Various loss functions appropriate for different tasks may be used. Softmax loss is used for predicting a single class of K mutually exclusive classes. Sigmoid cross-entropy loss is used for predicting K independent probability values in [0, 1]. Euclidean loss is used for regressing to real-valued labels.

In summary, FIG. 1 shows the data flow in a typical convolutional neural network. First, the input image is passed through convolutional layers and becomes abstracted to a feature map comprising several channels, corresponding to a number of filters in a set of learnable filters of this layer. Then, the feature map is subsampled using e.g. a pooling layer, which reduces the dimension of each channel in the feature map. Next, the data comes to another convolutional layer, which may have different numbers of output channels. As was mentioned above, the number of input channels and output channels are hyper-parameters of the layer. To establish connectivity of the network, those parameters need to be synchronized between two connected layers, such that the number of input channels for the current layers should be equal to the number of output channels of the previous layer. For the first layer which processes input data, e.g. an image, the number of input channels is normally equal to the number of channels of data representation, for instance 3 channels for RGB or YUV representation of images or video, or 1 channel for grayscale image or video representation. The channels obtained by one or more convolutional layers (and possibly resampling layer(s)) may be passed to an output layer. Such output layer may be a convolutional or resampling in some implementations. In an exemplary and non-limiting implementation, the output layer is a fully connected layer.

### Autoencoders and Unsupervised Learning

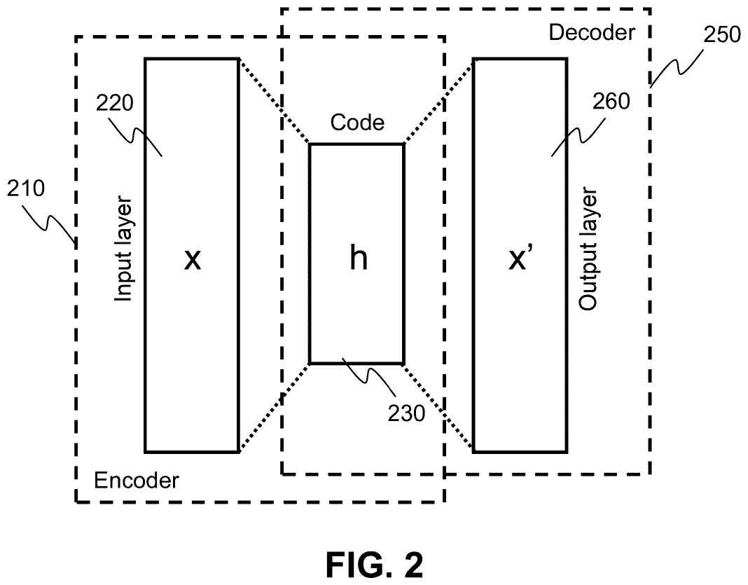

An autoencoder is a type of artificial neural network used to learn efficient data codings in an unsupervised manner. A schematic drawing thereof is shown in FIG. 2. The autoencoder includes an encoder side 210 with an input x inputted into an input layer of an encoder subnetwork 220 and a decoder side 250 with output x′ outputted from a decoder subnetwork 260. The aim of an autoencoder is to learn a representation (encoding) 230 for a set of data x, typically for dimensionality reduction, by training the network 220, 260 to ignore signal “noise”. Along with the reduction (encoder) side subnetwork 220, a reconstructing (decoder) side subnetwork 260 is learnt, where the autoencoder tries to generate from the reduced encoding 230 a representation x′ as close as possible to its original input x, hence its name. In the simplest case, given one hidden layer, the encoder stage of an autoencoder takes the input x and maps it to h

$$h = σ ( Wx + b ) .$$

This image h is usually referred to as code 230, latent variables, or latent representation. Here, u is an element-wise activation function such as a sigmoid function or a rectified linear unit. W is a weight matrix b is a bias vector. Weights and biases are usually initialized randomly, and then updated iteratively during training through Backpropagation. After that, the decoder stage of the autoencoder maps h to the reconstruction x′ of the same shape as x:

$${x}^{′} = {σ}^{′} ( {W}^{′} {h}^{′} + {b}^{′} )$$

where σ′, W′ and b′ for the decoder may be unrelated to the corresponding σ, W and b for the encoder.

Variational autoencoder models make strong assumptions concerning the distribution of latent variables. They use a variational approach for latent representation learning, which results in an additional loss component and a specific estimator for the training algorithm called the Stochastic Gradient Variational Bayes (SGVB) estimator. It assumes that the data is generated by a directed graphical model p_{θ}(x|h) and that the encoder is learning an approximation q_{φ}(h|x) to the posterior distribution p_{θ}(h|x) where φ and θ denote the parameters of the encoder (recognition model) and decoder (generative model) respectively. The probability distribution of the latent vector of a VAE typically matches that of the training data much closer than a standard autoencoder. The objective of VAE has the following form:

$$ℒ ( ϕ , θ , x ) = {D}_{KL} ( {q}_{ϕ} ( h \vert x ) \vert \vert {p}_{θ} ( h ) ) - {E}_{{q}_{ϕ} ( h \vert x )} ( log {p}_{θ} ( x \vert h ) )$$

Here, D_{KL} stands for the Kullback-Leibler divergence. The prior over the latent variables is usually set to be the centered isotropic multivariate Gaussian p_{θ}(h)= [symbol] (0, I). Commonly, the shape of the variational and the likelihood distributions are chosen such that they are factorized Gaussians:

$${q}_{ϕ} ( h \vert x ) = 𝒩 ( ρ ( x ) , {ω}^{2} ( x ) I )$$

$${p}_{ϕ} ( x \vert h ) = 𝒩 ( μ ( h ) , {σ}^{2} ( h ) I )$$

where ρ(x) and ω²(x) are the encoder output, while μ(h) and σ²(h) are the decoder outputs.

Recent progress in artificial neural networks area and especially in convolutional neural networks enables researchers' interest of applying neural networks based technologies to the task of image and video compression. For example, End-to-end Optimized Image Compression has been proposed, which uses a network based on a variational autoencoder.

Accordingly, data compression is considered as a fundamental and well-studied problem in engineering, and is commonly formulated with the goal of designing codes for a given discrete data ensemble with minimal entropy. The solution relies heavily on knowledge of the probabilistic structure of the data, and thus the problem is closely related to probabilistic source25isplacemg. However, since all practical codes must have finite entropy, continuous-valued data (such as vectors of image pixel intensities) must be quantized to a finite set of discrete values, which introduces an error.

In this context, known as the lossy compression problem, one must trade off two competing costs: the entropy of the discretized representation (rate) and the error arising from the quantization (distortion). Different compression applications, such as data storage or transmission over limited-capacity channels, demand different rate-distortion trade-offs.

Joint optimization of rate and distortion is difficult. Without further constraints, the general problem of optimal quantization in high-dimensional spaces is intractable. For this reason, most existing image compression methods operate by linearly transforming the data vector into a suitable continuous-valued representation, quantizing its elements independently, and then encoding the resulting discrete representation using a lossless entropy code. This scheme is called transform coding due to the central role of the transformation.

For example, JPEG uses a discrete cosine transform on blocks of pixels, and JPEG 2000 uses a multi-scale orthogonal wavelet decomposition. Typically, the three components of transform coding methods—transform, quantizer, and entropy code—are separately optimized (often through manual parameter adjustment). Modern video compression standards like HEVC, VVC and EVC also use transformed representation to code residual signal after prediction. The several transforms are used for that purpose such as discrete cosine and sine transforms (DCT, DST), as well as low frequency non-separable manually optimized transforms (LFNST).

### Variational Image Compression

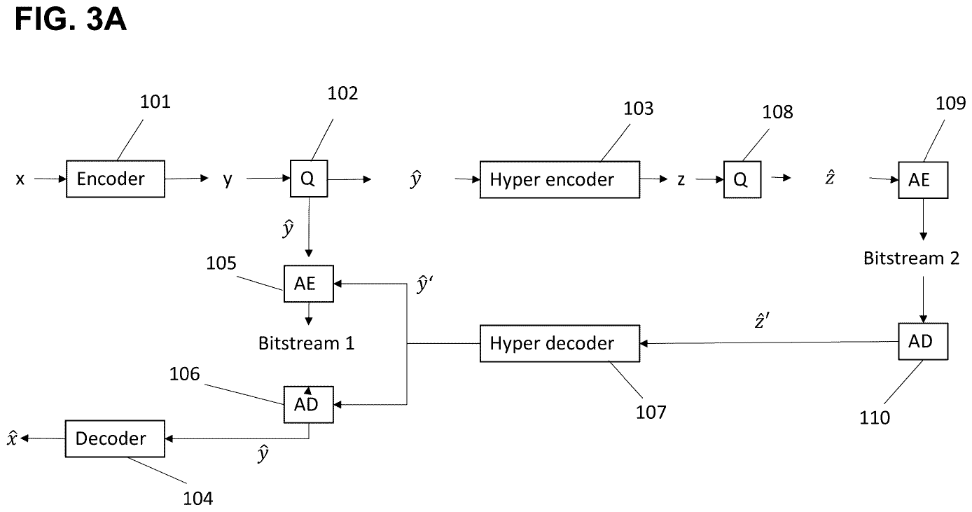

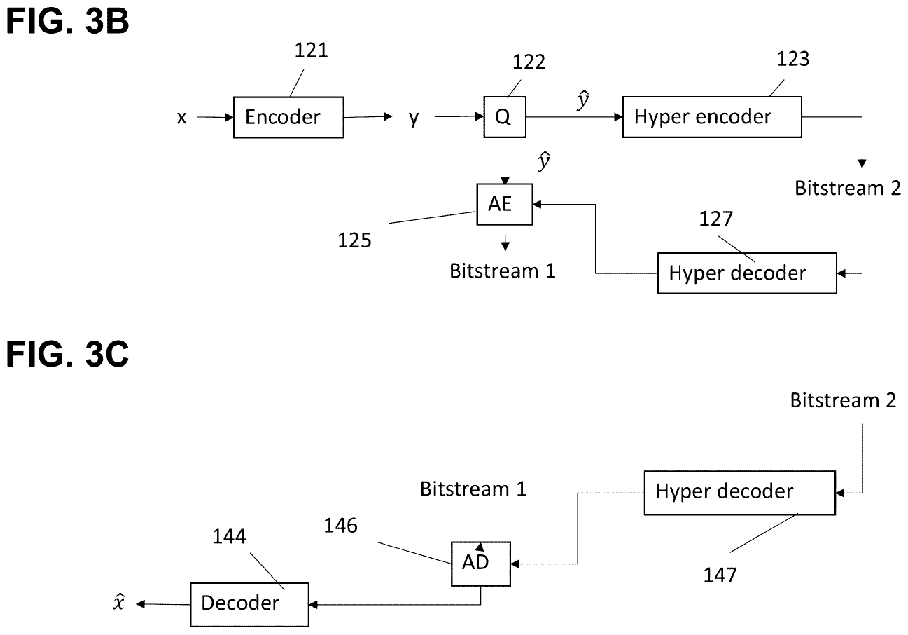

Variable Auto-Encoder (VAE) framework can be considered as a nonlinear transforming coding model. The transforming process can be mainly divided into four parts. This is exemplified in FIG. 3A showing a VAE framework.

The transforming process can be mainly divided into four parts: FIG. 3A exemplifies the VAE framework. In FIG. 3A, the encoder 101 maps an input image x into a latent representation (denoted by y) via the function y=f(x). This latent representation may also be referred to as a part of or a point within a “latent space” in the following. The function f( ) is a transformation function that converts the input signal x into a more compressible representation y. The quantizer 102 transforms the latent representation y into the quantized latent representation ŷ with (discrete) values by ŷ=Q(y), with Q representing the quantizer function. The entropy model, or the hyper encoder/decoder (also known as hyperprior) 103 estimates the distribution of the quantized latent representation ŷ to get the minimum rate achievable with a lossless entropy source coding.

The latent space can be understood as a representation of compressed data in which similar data points are closer together in the latent space. Latent space is useful for learning data features and for finding simpler representations of data for analysis. The quantized latent representation T, ŷ and the side information \hat{z} of the hyperprior 3 are included into a bitstream 2 (are binarized) using arithmetic coding (AE). Furthermore, a decoder 104 is provided that transforms the quantized latent representation to the reconstructed image \hat{x}, \hat{x}=g(ŷ). The signal \hat{x} is the estimation of the input image x. It is desirable that x is as close to \hat{x} as possible, in other words the reconstruction quality is as high as possible. However, the higher the similarity between \hat{x} and x, the higher the amount of side information necessary to be transmitted. The side information includes bitstream1 and bitstream2 shown in FIG. 3A, which are generated by the encoder and transmitted to the decoder. Normally, the higher the amount of side information, the higher the reconstruction quality. However, a high amount of side information means that the compression ratio is low. Therefore, one purpose of the system described in FIG. 3A is to balance the reconstruction quality and the amount of side information conveyed in the bitstream.

In FIG. 3A the component AE 105 is the Arithmetic Encoding module, which converts samples of the quantized latent representation ŷ and the side information \hat{z} into a binary representation bitstream 1. The samples of ŷ and \hat{z} might for example comprise integer or floating point numbers. One purpose of the arithmetic encoding module is to convert (via the process of binarization) the sample values into a string of binary digits (which is then included in the bitstream that may comprise further portions corresponding to the encoded image or further side information).

The arithmetic decoding (AD) 106 is the process of reverting the binarization process, where binary digits are converted back to sample values. The arithmetic decoding is provided by the arithmetic decoding module 106.

It is noted that the present disclosure is not limited to this particular framework. Moreover, the present disclosure is not restricted to image or video compression, and can be applied to object detection, image generation, and recognition systems as well.

In FIG. 3A there are two sub networks concatenated to each other. A subnetwork in this context is a logical division between the parts of the total network. For example, in FIG. 3A the modules 101, 102, 104, 105 and 106 are called the “Encoder/Decoder” subnetwork. The “Encoder/Decoder” subnetwork is responsible for encoding (generating) and decoding (parsing) of the first bitstream “bitstream1”. The second network in FIG. 3A comprises modules 103, 108, 109, 110 and 107 and is called “hyper encoder/decoder” subnetwork. The second subnetwork is responsible for generating the second bitstream “bitstream2”. The purposes of the two subnetworks are different.

The first subnetwork is responsible for:
the transformation 101 of the input image x into its latent representation y (which is easier to compress that x),
quantizing 102 the latent representation y into a quantized latent representation ŷ,
compressing the quantized latent representation ŷ using the AE by the arithmetic encoding module 105 to obtain bitstream “bitstream 1”,”.
parsing the bitstream 1 via AD using the arithmetic decoding module 106, and
reconstructing 104 the reconstructed image (\hat{x}) using the parsed data.

The purpose of the second subnetwork is to obtain statistical properties (e.g. mean value, variance and correlations between samples of bitstream 1) of the samples of “bitstream1”, such that the compressing of bitstream 1 by first subnetwork is more efficient. The second subnetwork generates a second bitstream “bitstream2”, which comprises the said information (e.g. mean value, variance and correlations between samples of bitstream1).

The second network includes an encoding part which comprises transforming 103 of the quantized latent representation ŷ into side information z, quantizing the side information z into quantized side information \hat{z}, and encoding (e.g. binarizing) 109 the quantized side information \hat{z} into bitstream2. In this example, the binarization is performed by an arithmetic encoding (AE). A decoding part of the second network includes arithmetic decoding (AD) 110, which transforms the input bitstream2 into decoded quantized side information \hat{z}′. The \hat{z}′ might be identical to \hat{z}, since the arithmetic encoding end decoding operations are lossless compression methods. The decoded quantized side information \hat{z}′ is then transformed 107 into decoded side information ŷ′. ŷ′ represents the statistical properties of ŷ (e.g. mean value of samples of ŷ, or the variance of sample values or like). The decoded latent representation ŷ′ is then provided to the above-mentioned Arithmetic Encoder 105 and Arithmetic Decoder 106 to control the probability model of ŷ.

The FIG. 3A describes an example of VAE (variational auto encoder), details of which might be different in different implementations. For example in a specific implementation additional components might be present to more efficiently obtain the statistical properties of the samples of bitstream 1. In one such implementation a context modeler might be present, which targets extracting cross-correlation information of the bitstream 1. The statistical information provided by the second subnetwork might be used by AE (arithmetic encoder) 105 and AD (arithmetic decoder) 106 components.

FIG. 3A depicts the encoder and decoder in a single figure. As is clear to those skilled in the art, the encoder and the decoder may be, and very often are, embedded in mutually different devices.

FIG. 3B depicts the encoder and FIG. 3C depicts the decoder components of the VAE framework in isolation. As input, the encoder receives, according to some embodiments, a picture. The input picture may include one or more channels, such as color channels or other kind of channels, e.g. depth channel or motion information channel, or the like. The output of the encoder (as shown in FIG. 3B) is a bitstream1 and a bitstream2. The bitstream1 is the output of the first sub-network of the encoder and the bitstream2 is the output of the second subnetwork of the encoder.

Similarly, in FIG. 3C, the two bitstreams, bitstream1 and bitstream2, are received as input and z, which is the reconstructed (decoded) image, is generated at the output. As indicated above, the VAE can be split into different logical units that perform different actions. This is exemplified in FIGS. 3B and 3C so that FIG. 3B depicts components that participate in the encoding of a signal, like a video and provided encoded information. This encoded information is then received by the decoder components depicted in FIG. 3C for encoding, for example. It is noted that the components of the encoder and decoder denoted with numerals 12x and 14x may correspond in their function to the components referred to above in FIG. 3A and denoted with numerals 10x.

Specifically, as is seen in FIG. 3B, the encoder comprises the encoder 121 that transforms an input x into a signal y which is then provided to the quantizer 322. The quantizer 122 provides information to the arithmetic encoding module 125 and the hyper encoder 123. The hyper encoder 123 provides the bitstream2 already discussed above to the hyper decoder 147 that in turn provides the information to the arithmetic encoding module 105 (125).

The output of the arithmetic encoding module is the bitstream1. The bitstream1 and bitstream2 are the output of the encoding of the signal, which are then provided (transmitted) to the decoding process. Although the unit 101 (121) is called “encoder”, it is also possible to call the complete subnetwork described in FIG. 3B as “encoder”. The process of encoding in general means the unit (module) that converts an input to an encoded (e.g. compressed) output. It can be seen from FIG. 3B, that the unit 121 can be actually considered as a core of the whole subnetwork, since it performs the conversion of the input x into y, which is the compressed version of the x. The compression in the encoder 121 may be achieved, e.g. by applying a neural network, or in general any processing network with one or more layers. In such network, the compression may be performed by cascaded processing including downsampling which reduces size and/or number of channels of the input. Thus, the encoder may be referred to, e.g. as a neural network (NN) based encoder, or the like.

The remaining parts in the figure (quantization unit, hyper encoder, hyper decoder, arithmetic encoder/decoder) are all parts that either improve the efficiency of the encoding process or are responsible for converting the compressed output y into a series of bits (bitstream). Quantization may be provided to further compress the output of the NN encoder 121 by a lossy compression. The AE 125 in combination with the hyper encoder 123 and hyper decoder 127 used to configure the AE 125 may perform the binarization which may further compress the quantized signal by a lossless compression. Therefore, it is also possible to call the whole subnetwork in FIG. 3B an “encoder”.

A majority of Deep Learning (DL) based image/video compression systems reduce dimensionality of the signal before converting the signal into binary digits (bits). In the VAE framework for example, the encoder, which is a non-linear transform, maps the input image x into y, where y has a smaller width and height than x. Since the y has a smaller width and height, hence a smaller size, the (size of the) dimension of the signal is reduced, and, hence, it is easier to compress the signal y. It is noted that in general, the encoder does not necessarily need to reduce the size in both (or in general all) dimensions. Rather, some exemplary implementations may provide an encoder which reduces size only in one (or in general a subset of) dimension.

In J. Balle, L. Valero Laparra, and E. P. Simoncelli (2015). “Density Modeling of Images Using a Generalized Normalization Transformation”, In: arXiv e-prints, Presented at the 4^{th} Int. Conf. for Learning Representations, 2016 (referred to in the following as “Balle”) the authors proposed a framework for end-to-end optimization of an image compression model based on nonlinear transforms. The authors optimize for Mean Squared Error (MSE), but use a more flexible transforms built from cascades of linear convolutions and nonlinearities. Specifically, authors use a generalized divisive normalization (GDN) joint nonlinearity that is inspired by models of neurons in biological visual systems, and has proven effective in Gaussianizing image densities. This cascaded transformation is followed by uniform scalar quantization (i.e., each element is rounded to the nearest integer), which effectively implements a parametric form of vector quantization on the original image space. The compressed image is reconstructed from these quantized values using an approximate parametric nonlinear inverse transform.

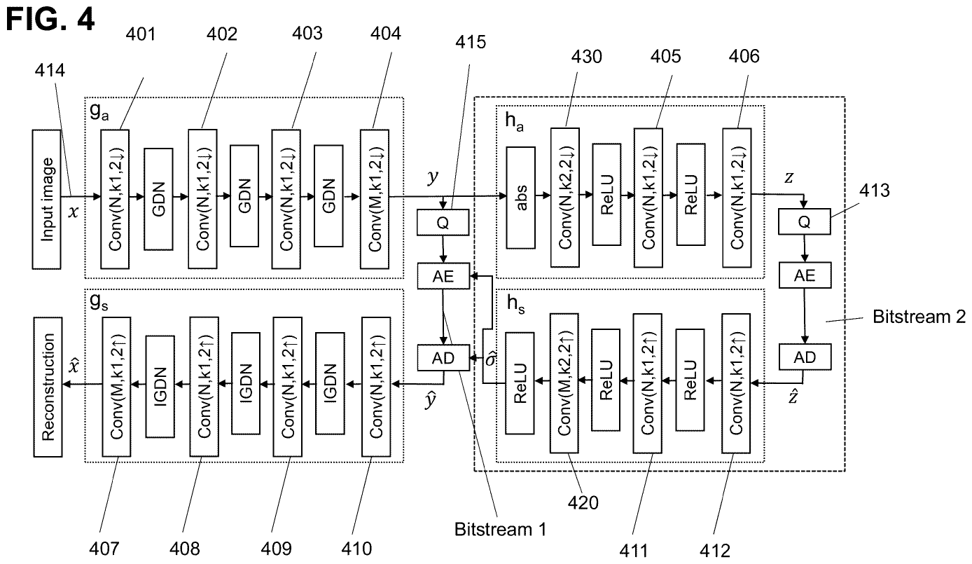

Such example of the VAE framework is shown in FIG. 4, and it utilizes 6 downsampling layers that are marked with 401 to 406. The network architecture includes a hyperprior model. The left side (gₐ, gₛ) shows an image autoencoder architecture, the right side (hₐ, hₛ) corresponds to the autoencoder implementing the hyperprior. The factorized-prior model uses the identical architecture for the analysis and synthesis transforms gₐ and gₛ. Q represents quantization, and AE, AD represent arithmetic encoder and arithmetic decoder, respectively. The encoder subjects the input image x to gₐ, yielding the responses y (latent representation) with spatially varying standard deviations. The encoding gₐ includes a plurality of convolution layers with subsampling and, as an activation function, generalized divisive normalization (GDN).

The responses are fed into hₐ, summarizing the distribution of standard deviations in z. z is then quantized, compressed, and transmitted as side information. The encoder then uses the quantized vector \hat{z} to estimate \hat{σ}, the spatial distribution of standard deviations which is used for obtaining probability values (or frequency values) for arithmetic coding (AE), and uses it to compress and transmit the quantized image representation ŷ (or latent representation). The decoder first recovers \hat{z} from the compressed signal. It then uses hₛ to obtain ŷ, which provides it with the correct probability estimates to successfully recover ŷ as well. It then feeds ŷ into gₛ to obtain the reconstructed image.

The layers that include downsampling is indicated with the downward arrow in the layer description. The layer description “Conv N,k1,2↓” means that the layer is a convolution layer, with N channels and the convolution kernel is k1×k1 in size. For example, k1 may be equal to 5 and k2 may be equal to 3. As stated, the 2↓ means that a downsampling with a factor of 2 is performed in this layer. Downsampling by a factor of 2 results in one of the dimensions of the input signal being reduced by half at the output. In FIG. 4, the 2↓ indicates that both width and height of the input image is reduced by a factor of 2. Since there are 6 downsampling layers, if the width and height of the input image 414 (also denoted with x) is given by w and h, the output signal z\hat{ } 413 is has width and height equal to w/64 and h/64 respectively. Modules denoted by AE and AD are arithmetic encoder and arithmetic decoder, which are explained with reference to FIGS. 3A to 3C. The arithmetic encoder and decoder are specific implementations of entropy coding. AE and AD can be replaced by other means of entropy coding. In information theory, an entropy encoding is a lossless data compression scheme that is used to convert the values of a symbol into a binary representation which is a revertible process. Also, the “Q” in the figure corresponds to the quantization operation that was also referred to above in relation to FIG. 4 and is further explained above in the section “Quantization”. Also, the quantization operation and a corresponding quantization unit as part of the component 413 or 415 is not necessarily present and/or can be replaced with another unit.

In FIG. 4, there is also shown the decoder comprising upsampling layers 407 to 412. A further layer 420 is provided between the upsampling layers 411 and 410 in the processing order of an input that is implemented as convolutional layer but does not provide an upsampling to the input received. A corresponding convolutional layer 430 is also shown for the decoder. Such layers can be provided in NNs for performing operations on the input that do not alter the size of the input but change specific characteristics. However, it is not necessary that such a layer is provided.

When seen in the processing order of bitstream2 through the decoder, the upsampling layers are run through in reverse order, i.e. from upsampling layer 412 to upsampling layer 407. Each upsampling layer is shown here to provide an upsampling with an upsampling ratio of 2, which is indicated by the T. It is, of course, not necessarily the case that all upsampling layers have the same upsampling ratio and also other upsampling ratios like 3, 4, 8 or the like may be used. The layers 407 to 412 are implemented as convolutional layers (conv). Specifically, as they may be intended to provide an operation on the input that is reverse to that of the encoder, the upsampling layers may apply a deconvolution operation to the input received so that its size is increased by a factor corresponding to the upsampling32isplacer, the present disclosure is not generally limited to deconvolution and the upsampling may be performed in any other manner such as by bilinear interpolation between two neighboring samples, or by nearest neighbor sample copying, or the like.

In the first subnetwork, some convolutional layers (401 to 403) are followed by generalized divisive normalization (GDN) at the encoder side and by the inverse GDN (IGDN) at the decoder side. In the second subnetwork, the activation function applied is ReLu. It is noted that the present disclosure is not limited to such implementation and in general, other activation functions may be used instead of GDN or ReLu.

### Cloud Solutions for Machine Tasks

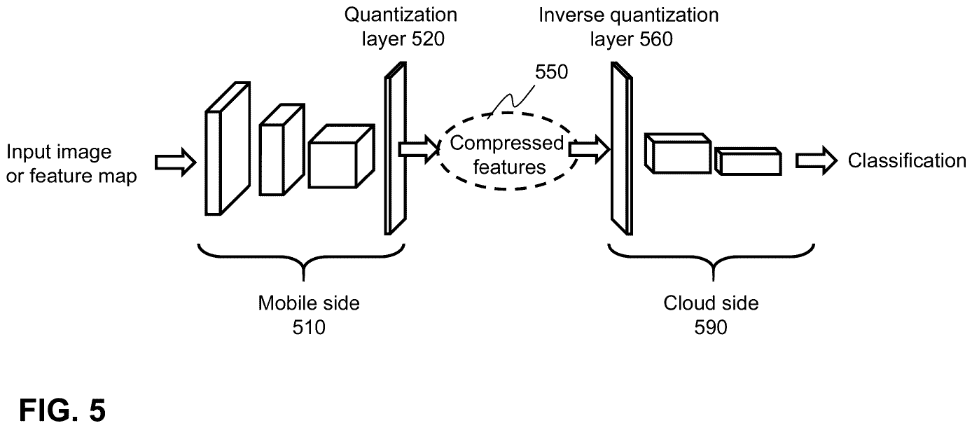

The Video Coding for Machines (VCM) is another computer science direction being popular nowadays. The main idea behind this approach is to transmit a coded representation of image or video information targeted to further processing by computer vision (CV) algorithms, like object segmentation, detection and recognition. In contrast to traditional image and video coding targeted to human perception the quality characteristic is the performance of computer vision task, e.g. object detection accuracy, rather than reconstructed quality. This is illustrated in FIG. 5.

Video Coding for Machines is also referred to as collaborative intelligence and it is a relatively new paradigm for efficient deployment of deep neural networks across the mobile-cloud infrastructure. By dividing the network between the mobile side 510 and the cloud side 590 (e.g. a cloud server), it is possible to distribute the computational workload such that the overall energy and/or latency of the system is minimized. In general, the collaborative intelligence is a paradigm where processing of a neural network is distributed between two or more different computation nodes; for example devices, but in general, any functionally defined nodes. Here, the term “node” does not refer to the above-mentioned neural network nodes. Rather the (computation) nodes here refer to (physically or at least logically) separate devices/modules, which implement parts of the neural network. Such devices may be different servers, different end user devices, a mixture of servers and/or user devices and/or cloud and/or processor or the like. In other words, the computation nodes may be considered as nodes belonging to the same neural network and communicating with each other to convey coded data within/for the neural network. For example, in order to be able to perform complex computations, one or more layers may be executed on a first device (such as a device on mobile side 510) and one or more layers may be executed in another device (such as a cloud server on cloud side 590). However, the distribution may also be finer and a single layer may be executed on a plurality of devices. In this disclosure, the term “plurality” refers to two or more. In some existing solution, a part of a neural network functionality is executed in a device (user device or edge device or the like) or a plurality of such devices and then the output (feature map) is passed to a cloud. A cloud is a collection of processing or computing systems that are located outside the device, which is operating the part of the neural network. The notion of collaborative intelligence has been extended to model training as well. In this case, data flows both ways: from the cloud to the mobile during back-propagation in training, and from the mobile to the cloud (illustrated in FIG. 5) during forward passes in training, as well as inference.

Some works presented semantic image compression by encoding deep features and then reconstructing the input image from them. The compression based on uniform quantization was shown, followed by context-based adaptive arithmetic coding (CABAC) from H.264. In some scenarios, it may be more efficient, to transmit from the mobile part 510 to the cloud 590 an output of a hidden layer (a deep feature map) 550, rather than sending compressed natural image data to the cloud and perform the object detection using reconstructed images. It may thus be advantageous to compress the data (features) generated by the mobile side 510, which may include a quantization layer 520 for this purpose. Correspondingly, the cloud side 590 may include an inverse quantization layer 560. The efficient compression of feature maps benefits the image and video compression and reconstruction both for human perception and for machine vision. Entropy coding methods, e.g. arithmetic coding is a popular approach to compression of deep features (i.e. feature maps).

Nowadays, video content contributes to more than 80% internet traffic, and the percentage is expected to increase even further. Therefore, it is critical to build an efficient video compression system and generate higher quality frames at given bandwidth budget. In addition, most video related computer vision tasks such as video object detection or video object tracking are sensitive to the quality of compressed videos, and efficient video compression may bring benefits for other computer vision tasks. Meanwhile, the techniques in video compression are also helpful for action recognition and model compression. However, in the past decades, video compression algorithms rely on hand-crafted modules, e.g., block based motion estimation and Discrete Cosine Transform (DCT), to reduce the redundancies in the video sequences, as mentioned above. Although each module is well designed, the whole compression system is not end-to-end optimized. It is desirable to further improve video compression performance by jointly optimizing the whole compression system.

### End-to-End Image or Video Compression

DNN based image compression methods can exploit large scale end-to-end training and highly non-linear transform, which are not used in the traditional approaches. However, it is non-trivial to directly apply these techniques to build an end-to-end learning system for video compression. First, it remains an open problem to learn how to generate and compress the motion information tailored for video compression. Video compression methods heavily rely on motion information to reduce temporal redundancy in video sequences.

A straightforward solution is to use the learning based optical flow to represent motion information. However, current learning based optical flow approaches aim at generating flow fields as accurate as possible. The precise optical flow is often not optimal for a particular video task. In addition, the data volume of optical flow increases significantly when compared with motion information in the traditional compression systems and directly applying the existing compression approaches to compress optical flow values will significantly increase the number of bits required for storing motion information. Second, it is unclear how to build a DNN based video compression system by minimizing the rate-distortion based objective for both residual and motion information. Rate-distortion optimization (RDO) aims at achieving higher quality of reconstructed frame (i.e., less distortion) when the number of bits (or bit rate) for compression is given. RDO is important for video compression performance. In order to exploit the power of end-to-end training for learning based compression system, the RDO strategy is required to optimize the whole system.

In Guo Lu, Wanli Ouyang, Dong Xu, Xiaoyun Zhang, Chunlei Cai, Zhiyong Gao; “DVC: An End-to-end Deep Video Compression Framework”. Proceedings of the IEEE/CVF Conference on Computer Vision and Pattern Recognition (CVPR), 2019, Ip. 11006-11015, authors proposed the end-to-end deep video compression (DVC) model that jointly learns motion estimation, motion compression, and residual coding.

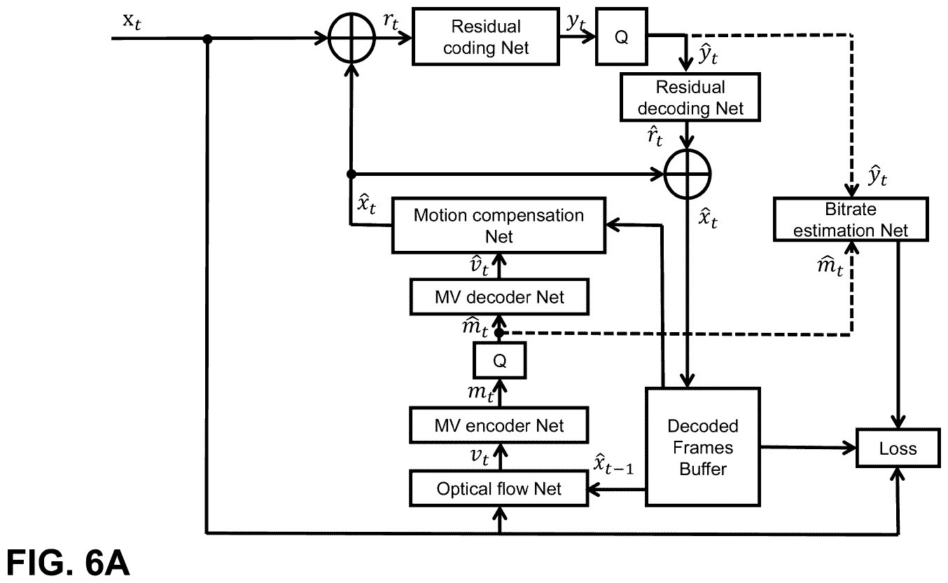

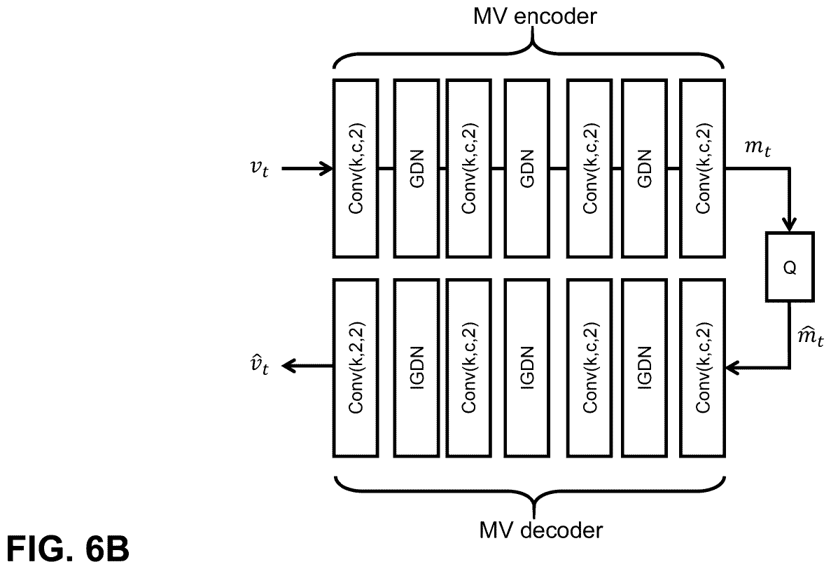

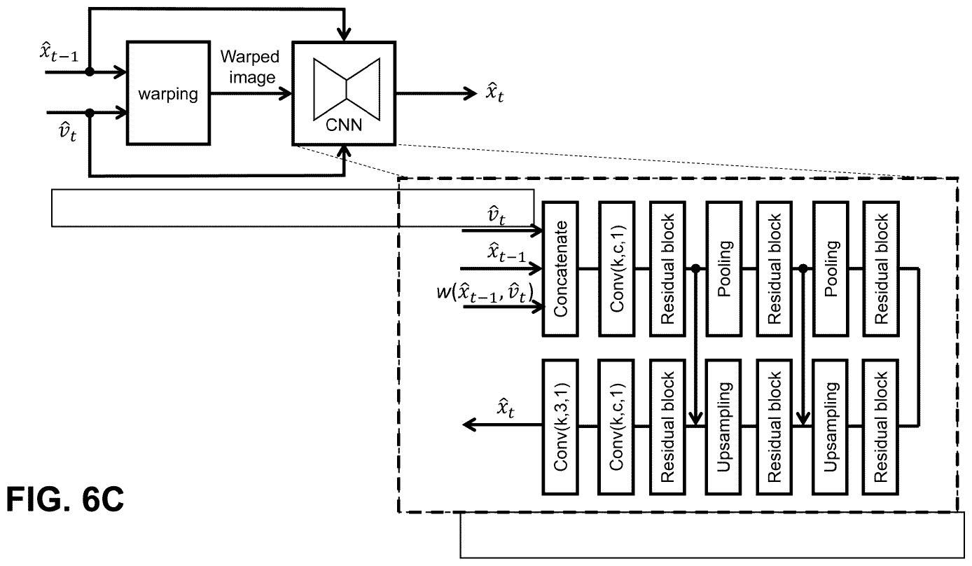

Such encoder is illustrated in FIG. 6A. In particular, FIG. 6A shows an overall structure of end-to-end trainable video compression framework. In order to compress motion information, a CNN was designated to transform the optical flow vₜ to the corresponding representations mt suitable for better compression. Specifically, an auto-encoder style network is used to compress the optical flow. The motion vectors (MV) compression network is shown in FIG. 6B. The network architecture is somewhat similar to the ga/gs of FIG. 4. In particular, the optical flow vₜ is fed into a series of convolution operation and nonlinear transform including GDN and IGDN. The number of output channels c for convolution (deconvolution) is here exemplarily 128 except for the last deconvolution layer, which is equal to 2 in this example. The kernel size is k, e.g. k=3. Given optical flow with the size of M×N×2, the MV encoder will generate the motion representation mt with the size of M/16×N/16×128. Then motion representation is quantized (Q), entropy coded and sent to bitstream as \hat{m}ₜ. The MV decoder receives the quantized representation \hat{m}ₜ and reconstruct motion information \hat{v}ₜ using MV encoder. In general, the values for k and c may differ from the above mentioned examples as is known from the art.

FIG. 6C shows a structure of the motion compensation part. Here, using previous reconstructed frame xₜ₋₁ and reconstructed motion information, the warping unit generates the warped frame (normally, with help of interpolation filter such as bi-linear interpolation filter). Then a separate CNN with three inputs generates the predicted picture. The architecture of the motion compensation CNN is also shown in FIG. 6C.

The residual information between the original frame and the predicted frame is encoded by the residual encoder network. A highly non-linear neural network is used to transform the residuals to the corresponding latent representation. Compared with discrete cosine transform in the traditional video compression system, this approach can better exploit the power of non-linear transform and achieve higher compression efficiency.

From above overview it can be seen that CNN based architecture can be applied both for image and video compression, considering different parts of video framework including motion estimation, motion compensation and residual coding. Entropy coding is popular method used for data compression, which is widely adopted by the industry and is also applicable for feature map compression either for human perception or for computer vision tasks.

### Video Coding for Machines

The Video Coding for Machines (VCM) is another computer science direction being popular nowadays. The main idea behind this approach is to transmit the coded representation of image or video information targeted to further processing by computer vision (CV) algorithms, like object segmentation, detection and recognition. In contrast to traditional image and video coding targeted to human perception the quality characteristic is the performance of computer vision task, e.g. object detection accuracy, rather than reconstructed quality.

A recent study proposed a new deployment paradigm called collaborative intelligence, whereby a deep model is split between the mobile and the cloud. Extensive experiments under various hardware configurations and wireless connectivity modes revealed that the optimal operating point in terms of energy consumption and/or computational latency involves splitting the model, usually at a point deep in the network. Today's common solutions, where the model sits fully in the cloud or fully at the mobile, were found to be rarely (if ever) optimal. The notion of collaborative intelligence has been extended to model training as well. In this case, data flows both ways: from the cloud to the mobile during back-propagation in training, and from the mobile to the cloud during forward passes in training, as well as inference.

Lossy compression of deep feature data has been studied based on HEVC intra coding, in the context of a recent deep model for object detection. It was noted the degradation of detection performance with increased compression levels and proposed compression-augmented training to minimize this loss by producing a model that is more robust to quantization noise in feature values. However, this is still a sub-optimal solution, because the codec employed is highly complex and optimized for natural scene compression rather than deep feature compression.

The problem of deep feature compression for the collaborative intelligence has been addressed by an approach for object detection task using popular YOLOv2 network for the study of compression efficiency and recognition accuracy trade-off. Here the term deep feature has the same meaning as feature map. The word ‘deep’ comes from the collaborative intelligence idea when the output feature map of some hidden (deep) layer is captured and transferred to the cloud to perform inference. That appears to be more efficient rather than sending compressed natural image data to the cloud and perform the object detection using reconstructed images.

The efficient compression of feature maps benefits the image and video compression and reconstruction both for human perception and for machine vision. Said about disadvantages of state-of-the art autoencoder based approach to compression are also valid for machine vision tasks.

### Functional Modules

### i) Variable Bitrate Module

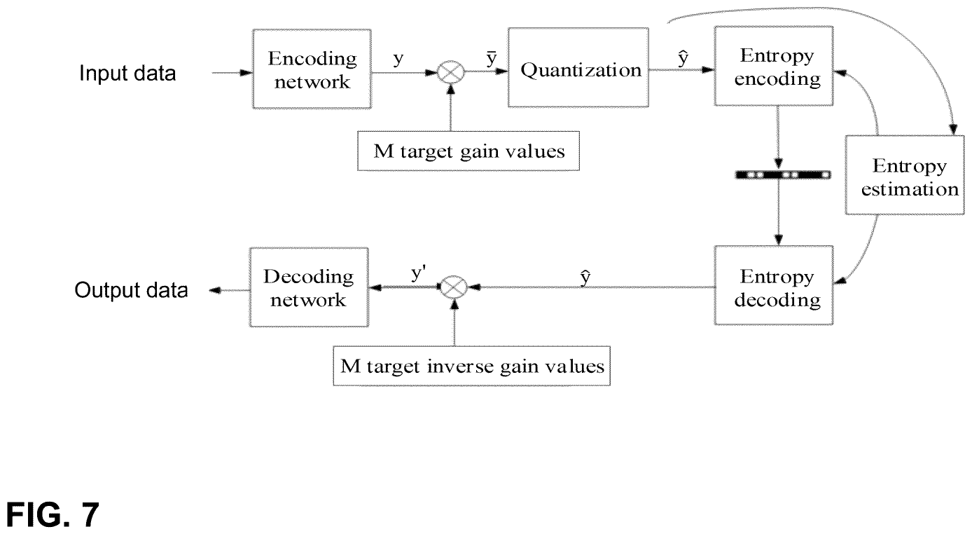

An encoder can output bitstreams at different bit rates. Therefore, in some methods, an output of an encoding network is scaled (for example, each channel is multiplied by a corresponding scaling factor that is also referred to as a target gain value), and an input of a decoding network is inversely scaled (for example, each channel is multiplied by a corresponding scaling factor reciprocal that is also referred to as a target inverse gain value), as shown in FIG. 7. The scaling factor may be preset, or may be selected based on a search. In embodiments of the present disclosure, the scaling factor may be referred to as a rate control parameter, or ‘Beta’. Different quality levels or quantization parameters correspond to different target gain values. If the output of the encoding network is scaled to a smaller value, a bitstream size may be decreased. Otherwise, the bitstream size may be increased.

### ii) Color Format Transform

RGB and YUV are common color spaces. Conversion between RGB and YUV may be performed according to an equation specified in standards such as CCIR 601 and BT.709.

iii) Separate Structure for Luma and Chroma

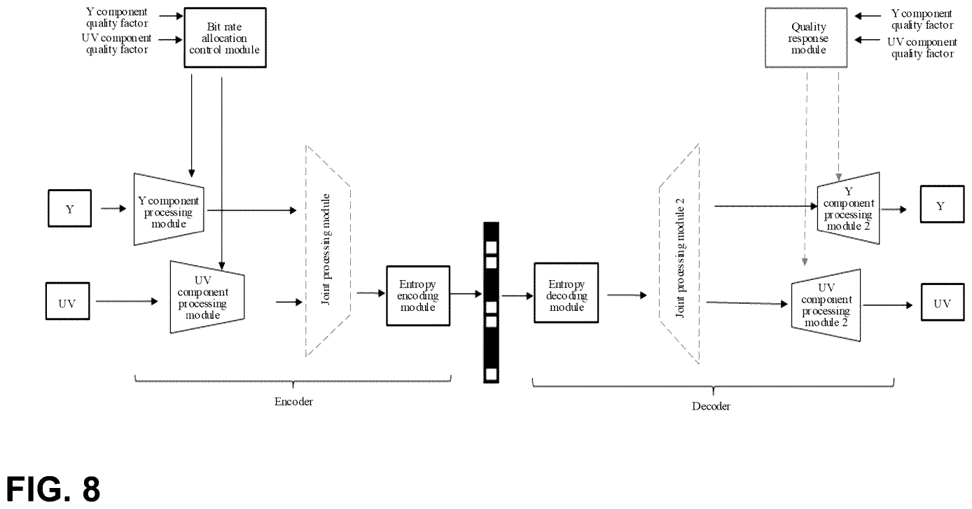

Some VAE-based codecs use the YUV color space as an input of an encoder and an output of a decoder, as shown in FIG. 8. A Y component indicates luma, and a UV component indicates chroma. Resolution of the UV component may be the same as or lower than that of the Y component. Typical formats include YUV4:4:4, YUV4:2:2, and YUV4:2:0. The Y component is converted into a feature map F_Y through a network, and an entropy encoding module generates a bitstream of the Y component based on the feature map F_Y. The UV component is converted into a feature map F_UV through another network, and the entropy encoding module generates a bitstream of the UV component based on the feature map F_UV. Under this structure, the feature map of the Y component and the feature map of the UV component may be independently quantized, so that bits are flexibly allocated for luma and chroma. For example, for a color-sensitive image, a feature map of a UV component may be less quantized, and a quantity of bitstream bits for a UV component may be increased, to improve reconstruction quality of the UV component and achieve better visual effect.

In some other methods, an encoder concatenates (concatenate) a Y component and a UV component and then sends to a UV component processing module (for converting image information into a feature map). In addition, a decoder concatenates a reconstructed feature map of the Y component and a reconstructed feature map of the UV component and then sends to a UV component processing module 2 (for converting a feature map into image information). In this method, a correlation between the Y component and the UV component may be used to reduce a bitstream of the UV component.

In the present specification, a ‘parameter’ is a value used in an operation process of each layer forming a neural network, and for example, may include a weight used when an input value is applied to a certain operation expression. Here, the parameter may be expressed in a matrix form. The parameter is a value set as a result of training, and may be updated through separate training data when necessary.

Exemplary methods and devices according to particular embodiments of the present disclosure will now be described in further detail. Embodiments of the preset disclosure may be used for the image coding scenario, where the bit rate matching is required to generate a specific bpp to satisfy the user's bandwidth. Moreover, embodiments of the present disclosure are also useful for the range of interest (ROI) case, such as surveillance/security camera.

### Definitions

The following definitions are provided for assistance in describing the following particular embodiments.

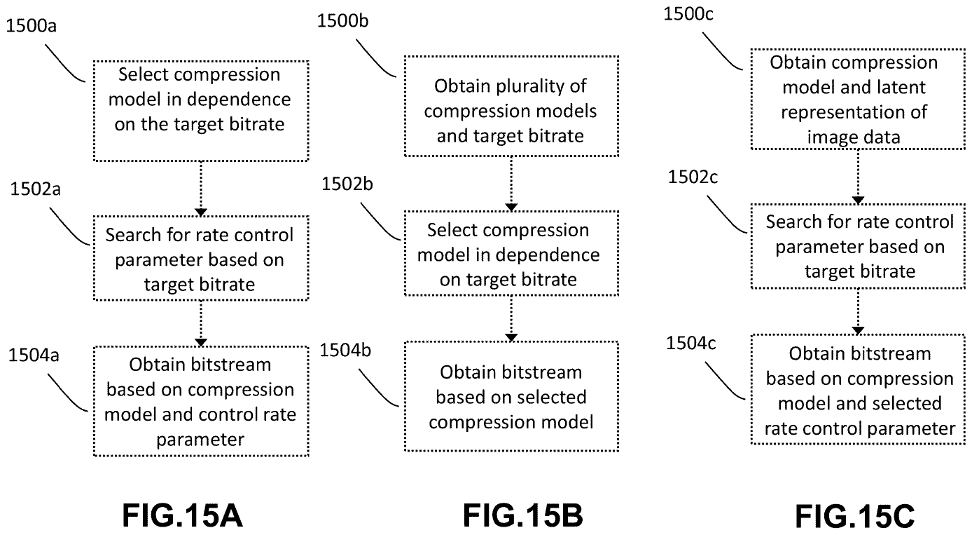

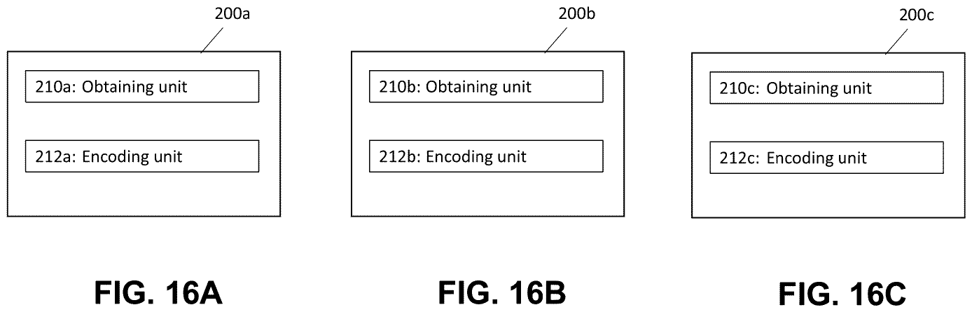

Codec: A neural network, or plurality of neural networks, that perform part or all of an encoding or decoding method. For example, a codec may refer to the complete encoding and decoding pipeline, or the respective decoding and encoding pipelines as shown in in FIGS. 15 and 16.

Entropy encoding: lossless procedure which converts a sequence of input tensor elements into a sequence of bits such that the average number of bits per symbol approaches the entropy of the input symbols.

Latent space: intermediate representation of image during encoding or decoding processes, tensor has three dimensions: horizontal, vertical and channel dimension

Bits per pixel (bpp): The average bits that codec spends for each pixel.

Bit rate matching (BRM): A process of the codec to provide a specific bpp.

Compression model: a neural network codec model that is trained by a training beta, same structure with different training betas generate different models.

Gain unit: a matrix that has multiple gain vectors. By using the extrapolation of one gain vector or interpolation between two gain vectors, the final gain vector will be generated and used for the latent tensor as a channel-wise quantization map.

rate control parameter (β): parameter, which defines quantization step for latent space.

β_{modelID}: the R for which the corresponding model was trained, during the training parameter β is used in the loss function as the trade-off controller between rate and distortion.

$${β}_{displacement} = β / {β}_{modelID}$$

β_{displacement_log}: converted β_{displacement} from linear domain to logarithmic domain by using LogToLinear function, it is equal to betaDisplacementLog in the CD text. 12-bits variable betaDisplacementLog equal to betaDisplacementLogY for primary and to betaDisplacementLogUV for secondary component.

LogToLinear: a table that used to convert standard deviation from logarithmic scale to linear and back. The values are stored in sigmaPrecision precision. Size of the table is equal to (N_{σ}−1)<<sigmaPrecision.

The LogToLinear table is obtained using equation:

$$σ ( idx ) = [ {2}^{17} \cdot exp ( \frac{idx \cdot ( ln ( {σ}_{max} ) - ln ( {σ}_{min} ) )}{( {N}_{σ} - 1 ) \cdot {2}^{sigmaPrecision}} + ln ( {σ}_{min} ) ) ]$$

$$for idx = 0 … ( ( {N}_{σ} - 1 ) sigmaPrecision ) - 1$$

where the ‘<<’ operator corresponds to a left-wise bit-shift operation (otherwise known as a left-shift operation).

It should be appreciated in the LogToLinear equation that the constant of 17 is merely an exemplary implementation. The power with which to raise 2, in this case 17, is a parameter that could be selected as any positive number in general, for example 0 to 64, to provide a desired tradeoff between computational complexity, table size, and the precision. More generally, all parameters in this equation can be selected individually by the particular codec.

Standard deviation values precision in integer representation sigmaPrecision=7 bits.

For arithmetic coder normal distribution with zero mean is used to estimate symbol probabilities. Standard deviation can be one of N_{σ}=35 values. All these values are within the range [σₘᵢₙ, σₘₐₓ] where minimal standard deviation σₘᵢₙ=0.11 and maximum standard deviation σₘₐₓ=100

$$Symmetric interval [ a , b ] : abs ( abs ( a ) - abs ( b ) ) \leq 1$$

### Decoder

As mentioned above, in some methods, an output of an encoding network is scaled (for example, each channel is multiplied by a corresponding scaling factor that is also referred to as a target gain value), and an input of a decoding network is inversely scaled (for example, each channel is multiplied by a corresponding scaling factor reciprocal that is also referred to as a target inverse gain value), as shown in FIG. 7. In the presently described embodiments, this scaling factor is referred to as the rate control parameter, or ‘beta’ (B). Specifically, this rate control parameter defines the quantization step for latent space. The latent space is an intermediate representation of the image data. During decoding, the latent space is obtained by processing the bitstream by a loss-less entropy-decoding algorithm. FIG. 16, which illustrates a particular embodiment of the decoder, shows this entropy decoder as me-tANS decoder”.

During decoding, the latent space is un-quantized in an inverse gain step, where an inverse gain is scaled by the rate control parameter, beta. Typically, in known examples, the rate control parameter used to decode the latent space is the same rate control parameter that has been used to encode the image data. The value of the rate control parameter used by the encoder is contained in the bitstream provided to the decoder. However, the inventors have established that it may be advantageous to use a different rate control parameter to decode the data, i.e., when applying the inverse gain to the quantized latent space, than the rate control parameter used to quantize the latent space during encoding. Furthermore, the inventors have established that an interval used to help select which rate control parameter to use for decoding may be an asymmetric interval.

The asymmetric interval may therefore be used to ‘clip’ the value of the rate control parameter used for the encoding, such that the clipped value of the rate control parameter is used to decode the quantized latent space. Specifically, the asymmetric interval is wider at low end, which in turns provides that the probability of ‘clipping’ a lower value of the rate control parameter is smaller than the probability of clipping a greater value of the rate control parameter. Preferably, the possible range of rate control parameters is cantered about zero (more preferably, defined by the interval [−2ⁿ, 2ⁿ−1], where n is an integer). However, in general, the asymmetry of the interval may be defined such that an asymmetry of the asymmetric interval is characterised in that a first magnitude, defined by a difference between a largest representable value of the rate control parameter (e.g., 2ⁿ−1) and the upper rate control threshold, is greater than a second magnitude defined by a difference between a smallest representable value of the rate control parameter (e.g., −2ⁿ) and the lower rate control threshold.

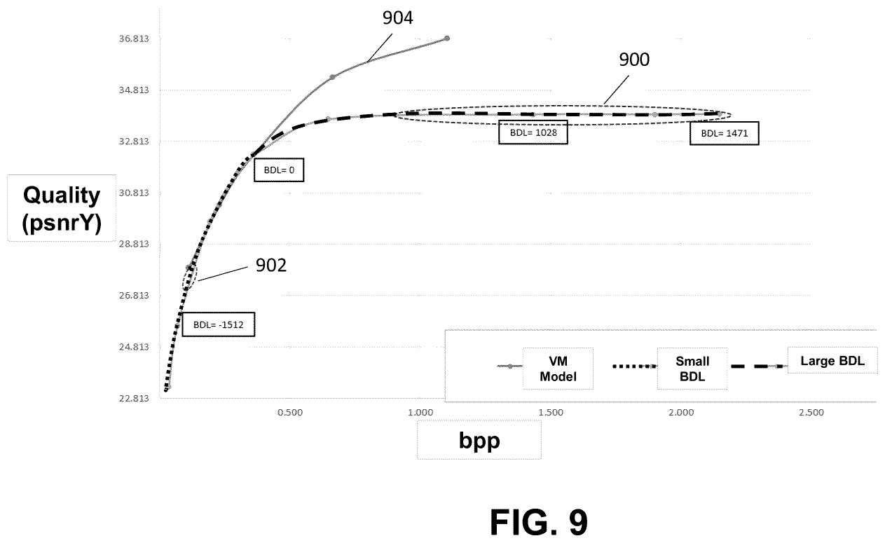

FIG. 9 illustrates a graph indicating a plurality of compression models used for encoding and decoding in embodiments of the present disclosure, which helps provide the background for establishing the asymmetric interval of the present embodiments. The solid line 904 labelled “VM model” represents an idealised compression model, which in fact comprises a plurality (four) of models. This line is referred to as the ‘combined model’ 904. The combined model has been trained using different beta values (i.e., different rate control parameters) so as to provide an ideal benchmark across a range of bitrate (i.e., bits per pixel or bpp) outputs. Specifically, FIG. 9 shows the performance of the JPEG-AI verification model (VM4.1) over CTTC test dataset. CTTC test dataset contains 50 images that cover different natural cases. The solid curve 904 combines 4 models at four points, in which each point's betaDisplacementLog (BDL) value is 0. This line 904 defines the performance envelop of the variable rate performance.

The horizontal axis of the graph thus represents the output bitrate measured in bits per pixel (bpp), and the vertical axis measures the quality of compression (peak signal-to-noise ratio, or psnr) for the ‘Y’ component of the image (i.e., the chroma component) for the given beta value. Thus, the solid line of the combined model represents the ‘ideal envelope’ defining an ideal, or at least a desirable, set of compression characteristics across a range of rate control parameters.

As described above in the definition section, the rate control parameter is indicated by the Beta Displacement Log (BDL) for different rate control parameters in FIG. 9. The BDL value is obtained by obtaining β_{displacement}=β/β_{modelID}, and then converting β_{displacement} to logarithmic space using the LogToLinear equation above (or, more preferably, a precomputed table of LogToLinear values, computed using the LogToLinear equation). In other words, the BDL defines a ratio (or, specifically, a logarithm of a ratio) between the rate control parameter beta (β) selected by the encoder for a particular component and the beta (#_{modelID}) used in the model training.

Therefore, in FIG. 9, as in preferable embodiments of the bitstream used by the encoder, the BDL value has the range of values defined by [−2ⁿ⁻¹, 2ⁿ⁻¹−1], is 12 bits, giving a range of [−2048, 2047]. Generally, it will be understood that, although beta (β) is the rate control parameter that may be used by parts of the encoder or decoder to apply a scaled gain to the quantized or unquantized latent space, for convenience, the rate control parameter is indicated to the decoder in terms of BDL, preferably in the 12-bit range described above.

FIG. 9 indicates the point at which BDL=0 on the graph. The dashed line corresponds to a compression model trained using only one β_{modelID}. In this case, the value of β_{modelID} is 0.015. The parts of the compression model using β_{modelID}=0.015 where BDL<“(“Small “DL” in FIG. 9) are indicated using the dotted line, and the portion in which where BDL>” (“large BDL” in FIG. 9) are indicated using the dashed line. Specifically, the “large BDL” line uses the middle model of the ideal curve 904 and only generates values for BDL>0: as can be seen, it has a large gap from the desired performance envelop 904. The “Small “DL” curve uses the same compression model as the “large BDL” curve and only generates output for BDL<0.

It can be observed that, for smaller values of BDL, i.e., where BDL<0, the bitrate output in bpp deviates from the desirable envelope defined by ‘combined model’ 904 by only a small amount. The small deviation of small-value BDL values is indicated by deviation 902. By contrast, where BDL>0, the bitrate output in bpp deviates from the desirable envelope defined by ‘combined model’ 904 by a greater amount. The large deviation of larger BDL values is indicated by deviation 900.

Consequently, in known decoding methods that use compression models such as the one indicated in FIG. 9 (e.g., trained using β_{modelID}=0.015), the decoding codec may use rate control parameters that are either too big or too small to provide an increased benefit. For example, for small values of BDL within the region indicated by deviation point 902, it can be seen that the same bitrate output (bpp) corresponds to a lower quality decoded image. Consequently, it would be disadvantageous to select a beta value corresponding to a BDL value within this deviation region 902 (or lower), and the resulting decoded image would be of poorer quality than desired.

Furthermore, for large values of BDL within the region indicated by deviation point 900, it can be seen that selecting a higher BDL value, which intuitively and based on the ideal ‘combined model’ 904 should result in a higher quality decoded image, selecting a higher BDL value in reality produces no increase in quality. For example, BDL value of 1028 and 1471 produce the same quality output (in terms of psnrY) despite the fact that, in theory, a higher bpp should be obtained, corresponding to a higher quality compression. This means that the decoding codec may be wasting resources by using more bits than necessary signalling a BDL value that confers no increase in decoding quality.

In known decoding systems, there is the potential that the decoding codec will inadvertently cause a performance drop by choosing a rate control parameter, indicated by BDL, that is either too large or too small. As indicated by the graph, there is a significantly higher probability that a BDL value will be chosen that is too large, given the sharp deviation from the desirable envelope 904 caused by large BDL values.

Consequently, the inventors have established that it is beneficial and advantageous to impose an asymmetric interval of the allowed BDL values, e.g. wherein the asymmetric interval has a smaller tolerance towards higher β values and greater tolerance towards lower R values. In other words, the preferred asymmetric interval is wider at the lower end. In known decoding systems, the allowed betaDisplacementLog (BDL) range is symmetrical (where a symmetrical interval is defined as [a, b]: abs(abs(a)−abs(b))≤1, provided that the interval is of the [−2ⁿ⁻¹, 2ⁿ⁻¹−1] format for values centered about zero), which causes performance drop when β is much larger than β_{modelID}. Meanwhile, the similar displacement towards lower β values doesn't cause problems of the same magnitude. Thus, since the positive BDL values deviate faster from the envelope than the negative BDL values, an asymmetric clipping interval is obtained.

As shown in FIG. 9, without any clipping of betaDisplacementLog (BDL), the codec may use too great or too small quality parameters, which may lead to an unnecessary performance drop. For example, although a betaDisplacementLog=1471 is within the currently allowed range of [−2048,2047], the deviation from the performance envelope 904 of this value (marked in FIG. 9 towards the right-hand extremity of the “Large BDL” curve) is large.

Since the codec performance for higher rate control parameters and lower rate control parameters deviate to different extents, clipping betaDisplacementLog in a symmetrical manner would not be reasonable. Consequently, the solution is to impose the following clipping regime on the currently-allowed BDL values of [−2048, 2047](corresponding to [−2ⁿ⁻¹, 2ⁿ⁻¹−1] for a bit-depth of n=12):
i) Impose bounds on the allowed values of β_{displacement_log} by bounding as follows β_{min_log}≤β_{displacement_log}≤β_{max_log}
ii) in which the bounding interval is non-symmetric abs(abs(β_{min_log})−abs(β_{max_log}))>1
iii) in which the asymmetry of the bounding interval is characterised by being wider at the low end: i.e., for representable values of [−2ⁿ⁻¹, 2ⁿ⁻¹−1], the boundary may be defined as abs(β_{min_log})>abs(β_{max_log})

In other words, beta_dispalcement_log is signalled in the bitstream with bit-depth of n as [0, 2ⁿ]. After reading the value of beta_dispalcement_log from the bitstream, a symmetric offset (of −2ⁿ⁻¹) is initially applied to obtain betaDisplacementLog (BDL) that has the range [−2ⁿ⁻¹, 2ⁿ⁻¹−1]. The asymmetric interval is obtained when this range is clipped to form the non-symmetric interval abs(abs(β_{min_log})−abs(β_{max_log}))>1.

In the present disclosure, the bounds of the interval β_{min_log} and β_{max_log} may be referred to as a ‘lower rate control threshold’ and an ‘upper rate control threshold’, respectively. In examples, the representable values of the rate control parameter may be positive, or unsigned, integers, e.g., such that the representable values of the rate control parameter are [Rl, Ru]=[0, 2ⁿ] for some bit-depth n. Here, the clipped boundary may be defined as [Cl, Cu]=[Rl+1, Ru−m]=[l,−ⁿ−m] in which m>1. Therefore, in general, the asymmetric interval may be characterised in that a first magnitude defined by a difference (e.g., abs(abs(Ru)−abs(Cu))=m) between a largest representable value (e.g., Ru) of the rate control parameter and the upper rate control threshold (e.g., Cu) is greater than a second magnitude defined by a difference (e.g., abs(abs(Rl)−abs(Cl))=1) between a smallest representable (e.g., Rl) value of the rate control parameter and the lower rate control threshold (e.g., Cl).

The inventors have established that the asymmetric interval may be defined such that the BDL values at the extremes of the interval produce roughly the same, tolerable, deviation from the performance envelope 904. In other words, the asymmetric interval may be defined empirically based on a deviation tolerance, such that no value of BDL used by the decoder can produce a performance that is outside of the deviation tolerance from the performance envelope. In one specific example where BDL values are signalled in the bitstream using 12 bits (n=12), such that allowable range of BDL values is [−2ⁿ⁻¹, 2ⁿ⁻¹−1]=[−2048, 2047], a suitable asymmetric interval can be defined as [−1069, 702], i.e., where −1069 represents the lower rate control threshold and where 702 represents the upper rate control threshold.

In one particular embodiments, the value of BDL having been used by the encoder and a given compression model may be signalled as a 12-bit integer, i.e., [0, 4095] (beta_displacement_log). Thus, the decoder can be configured to take this value obtain the clipped BDL value as follows: betaDisplacementLog=clip(−1069, 702, beta_displacement_log−2¹¹). Thus, is the value of beta_displacement_log−2¹¹ is greater than 702, the value of BDL will be clipped to exactly 702, and if the value of beta_displacement_log−2¹¹ is less than −1069, the value of BDL will be clipped to exactly −1069. If the BDL signalled in the bitstream (specifically, beta_displacement_log−2¹¹) is within the [−1069, 702] inclusive of the endpoints, the value is not clipped.

In preferred embodiments, the decoder will perform this method twice, once for each component of the encoded image data, having been encoded separately as luma (Y) and chroma (UV) values. Each of the luma and Chroma components may have their own bitstream, and each will have their own associated compression models (defined by the model ID, β_{modelID}) and a beta value used to compress the image component. Thus, the decoder may perform up to two clipping operations, once for the Y component and once for the UV component. It is noted again that FIG. 9 illustrates a compression model and performance envelope only for the ‘Y’ component of a set of images.

The inventors have also established an alternative method for clipping the value of BDL. In this embodiment, advantageously, the value of beta_displacement_log signalled in the bitstream is signalled using only 11 bits, as opposed to 12 bits, thus saving one bit of data. Specifically, the BDL value is signalled as beta_displacement_log, within the range of [0, 2047]. In this example, rather than subtracting 2ⁿ⁻¹ from the value signalled in the bitstream (i.e., 2¹¹ in the example above) and clipping the value, an offset is subtracted from this value where abs(offset)>interval size/2. In other words, the offset is greater than half of the maximum representable value defined by the interval size. For example, the offset can be set as −1069, such that betaDisplacementLog is [0−1069, 2047−1069]=[−1069, 978]. Consequently, to obtain the empirically obtained asymmetric interval described above of [−1069, 702] only the positive side of the interval needs to be clipped from [−1069, 978] to obtain [−1069, 702]. Consequently, this embodiment has the advantage that only 11 bits, instead of 12, are used to signal the BDL values, and confers the additional advantage that only one comparison operation (with the upper, 702, interval threshold) needs to be performed with the signalled BDL value, since the lower BDL range is intrinsically clipped by the offset value.

Alternatively, in some examples, it can be sufficient to simply apply the asymmetric offset to obtain the range of BDL values (e.g., [−1069, 978]) without needing to apply a further clipping to the upper threshold. Specifically, the range of values obtainable by subtracting the offset (where abs(offset)>interval size/2) can be sufficient to ensure absence of the performance drop from the desired envelope 904.

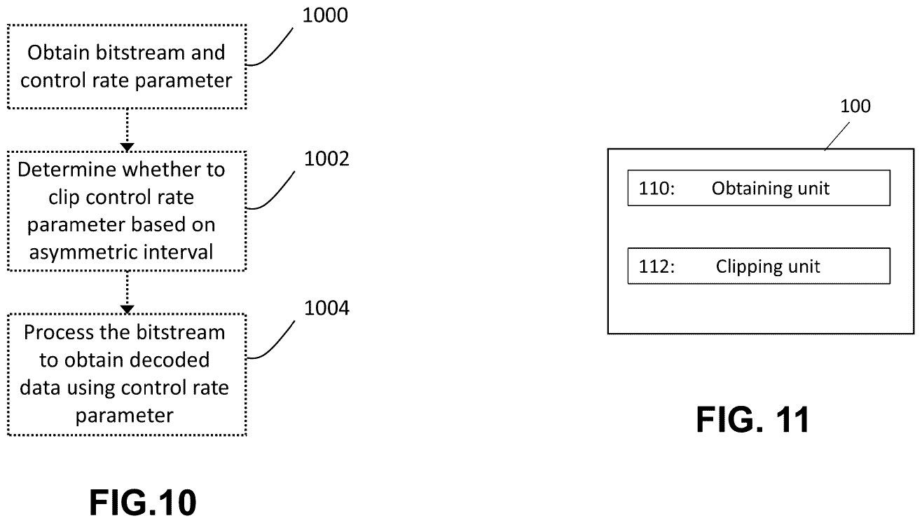

FIG. 10 is a flow diagram illustrating an exemplary method for decoding an image based on a neural network architecture. This described the decoding method in general terms, which involve step 1000 at which the bitstream is obtained. The bitstream includes information of the control rate parameter (BDL) used to compress the encoded data, this the control rate parameter is also obtained. At step 1002, it is determined whether the control rate parameter needs to be clipped, as described above, in dependence on the upper and lower control rate thresholds defined by the pre-determined asymmetric interval. At step 1004, the determined (potentially clipped) control rate parameter is used to decode the data in the bitstream. Specifically, the control rate parameter can be used to un-quantized the quantized latent space, which can then be transformed back into image data (or, a Y or UV component of the image data).

FIG. 11 shows a device 100 for decoding for processing by a neural network-based unit. The device comprises obtaining unit 110 configured to obtain, from the bitstream, a rate control parameter (e.g., the BDL signalled in the bitstream) having been used to encode the data for picture or video data by an encoder model (e.g., a compression model), wherein the rate control parameter indicates a compression ratio. The obtaining unit is also configured to obtain an asymmetric interval defined by an upper rate control threshold and a lower rate control threshold, wherein an asymmetry of the asymmetric interval is characterised in that a first magnitude defined by i) a difference between a largest representable value of the rate control parameter and the upper rate control threshold is greater than a second magnitude defined by ii) a difference between a smallest representable value of the rate control parameter and the lower rate control threshold. The device 100 also contains a clipping unit configured to:
determine whether a value of the rate control parameter lies outside of a range of the asymmetric interval; and
in response to determining that the value of the rate control parameter lies outside of the range of the asymmetric interval, clip the rate control parameter to obtain a clipped rate control parameter, the clipping comprising:
   if the value of the rate control parameter is greater than the upper rate control threshold, setting the clipped rate control parameter equal to the upper rate control threshold; and
   if the value of the rate control parameter is smaller than the lower rate control threshold, setting the clipped rate control parameter equal to the lower rate control threshold.

### Encoder

Particular embodiments of the encoder according to the present disclosure will now be described in more detail with reference to the accompanying figures.

When compressing image data, or a Y or UV component thereof, the encoding codec selects a compression model from a plurality of competition models. Each compression model has been trained based on a rate control parameter, β_{modelID}, sometimes referred to as the ‘default rate control parameter’ in presently disclosed embodiments. Broadly speaking, the inventors have established improved methods of performing bit rate matching (BRM) for compression models when performing encoding using a variable rate codec (e.g., implemented using neural networks).

The plurality of compression models (in preferred cases, about five model) are trained for different range of quality (i.e., different compression rates/different ranges of bpp). A compression model is selected in dependence at least on a target compression rate (also referred to as ‘target bitrate’). After the compression model has been selected, a search is performed to find a rate control parameter, P, that will enable the selected model to achieve the target bitrate. A trial rate control parameter may also be evaluated to test its suitability, i.e., to determine whether the output bitrate of the selected compression model and the trial bitrate is within an acceptable tolerance of the target bitrate.

In known encoding methods, the compression model is selected based on the BRM performance of all models. In other words, all compression models are tested and evaluated to determine which compression model is capable of producing the smallest loss, wherein the loss is determined as between the original image data and the decoded image data (having been encoded by each of the compression models under investigation). When selection a compression model based on BRM, when one compression model is determines which generate a bpp that is close (i.e., within an acceptable tolerance) to target bpp, this compression model is set as one candidate. Multiple candidates may therefore be selected, since multiple models are likely to be able to generate a bpp that is within the tolerance. Finally, the candidate compression model that produces the smallest loss will be selected. In known systems, the loss may contain MSE and MSSSIM (described in detail below) with different weights. This system has the disadvantage that multiple models must be tested simultaneously, and also has the disadvantage that the computationally expensive loss must be completed for each compression model. The selection process is therefore computationally intensive and slow.

Furthermore, in known systems, for each model to reach the target bpp, different betaDisplacementLog values (BDL) need to be evaluated to check whether the bpp generated by the candidate compression model is close enough to the target bpp. The betaDisplacementLog is typically updated by binary search in known compression models. This has the disadvantage that multiple searches for BDL are carried out in tandem. Furthermore, the binary search can be slow because there is no direction as to where to search for a good candidate beta value: in other words, the search is blind.

Yet further, in known BRM methods, when evaluating different betaDisplacementLog (BDL) values, there is a need to evaluate the performance with the codec (i.e., including encoding and decoding) to get the final bpp. This is because, in order to calculate the loss, the final decoded image must be produced for comparison with the original image data.

The inventors have established various improvements to the known BRM process, which are described as follows:

### 1) Improved Compression Model Selection

Known methods test multiple compression models through to completion, i.e., including running the entire codec on each candidate compression model and calculating a loss for each model, in order to select a compression model. The inventors have established that, surprisingly, it is possible to select a good compression model in isolation from the BDL search and evaluation steps. Moreover, the inventors have established that it is possible to choose a compression model from a plurality of compression models based only on the target bitrate.

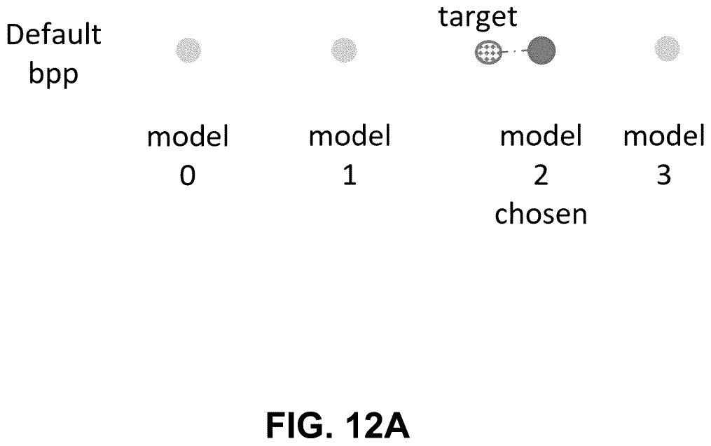

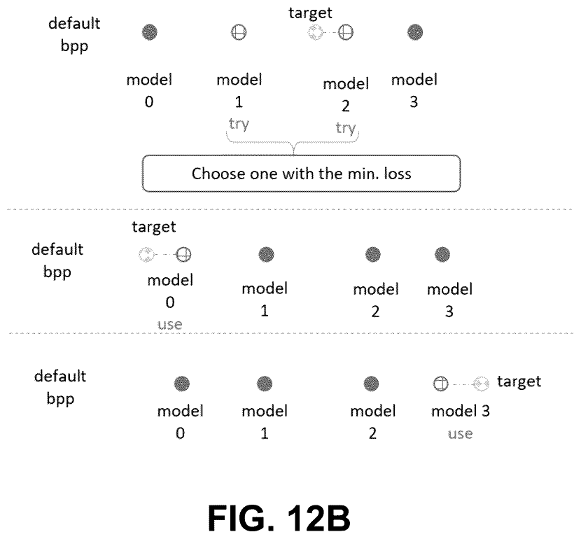

FIG. 12A illustrates the method for selecting a compression model. Four candidate compression models are indicated in FIG. 12A, where each compression model is associated with a default rate control parameter (also called β_{modelID}), where the default rate control parameter was used to train the compression model. Each compression is therefore associated with a range of output bpp values, e.g., similar to the range of bpp values spanned by the model shown in FIG. 9.

A compression model Is selected purely based on the ‘relative bit distance’ between the target bitrate (i.e., the target bpp) and a bpp associated with the default rate control parameter of each compression model. The concept of the relative bit distance is defined as follows:

$$Relative bit distance = abs ( {bpp}_{default} - {bpp}_{target} ) / {bpp}_{default} , where$$

$${bpp}_{default} is generated by using {β}_{displacement \_ log} = 0 ( {β}_{displacement} = 1 ) .$$

It is noted that, in some cases, the bpp_{default} of the candidate compression models is obtained by running part of the encoding codec in dependence on the compression model (using BDL=0 as the input). However, the decoder is not needed to obtain the default bpp, since the loss for each candidate, advantageously, does not need to be calculated. As shown in FIG. 12A, the default bpp of compression model 2 is closest, in terms of relative bit distance, to the target bitrate (labelled ‘target’). Consequently, compression model 2 is chosen as the compression mode, for which beta searching may subsequently be carried.

It will be appreciated that, at most, four iterations of the encoder codec are needed to perform the selection of the compression mode, i.e., because the codec may be run for each compression model to determine its respective default bpp (bpp_{default}). This is in contrast to known methods which need to perform at least eight iterations of the encoder codec, because the minimum and maximum bpp for each compression model needed to be calculated in order to determine whether their bpp range encompassed the target bitrate. The presently disclosed improvement is therefore significantly faster in selecting a candidate compression model from the outset. In some examples, it will be appreciated that the bpp_{default} may be supplied with the compression model, i.e., it may be pre-determined offline, such that the encoder need not perform a live search for the default bpp for each compression model.

FIG. 12B illustrates a further example for selecting a candidate model. In this example, at most two candidate models are selected at the outset in the same manner as in FIG. 12 A. The two models are selected, again, based on the relative bit distance. Thus, the two models having the closest relative bit distance to the target bpp are selected. FIG. 12B indicates that models 1 and 2 are chosen. In other words, the two models are chosen whose respective default bpp value fall either side of the target bpp. If, in this embodiment, the target bpp is lower than the lowest value of the default bpp for all of the compression models, the compression model with the lowest default bpp is chosen (as indicated in the central example in FIG. 12B where model 0 is chosen). Similarly, if, in this embodiment, the target bpp is greater than the highest value of the default bpp for all of the compression models, the compression model with the greatest default bpp is chosen (as indicated in the bottom example in FIG. 12B where model 3 is chosen).

Once the two compression models are chosen (e.g., models 1 and 2 as indicated in the top-most example of FIG. 12B), a search for BDL is performed for both of them (described below in more detail) after which the BDL chosen for each of them is evaluated by calculating a loss for each compression model. Therefore, in this example, the decoder is run in order to decompress the bitstream obtained by the candidate models, so that the decoded result for each compression model can be compared against the original image data. Preferably, the loss is calculated based on MSE and MSSSIM with an appropriate weighting for each loss component value. The model with the smallest loss is thus chosen. Although this method takes slightly longer than the 12A embodiment, for example because it uses two loss calculations, it has the advantage that it can select a more appropriate compression model based on an actual loss. For example, it may be advantageous to use this model when the target bpp bitrate lies equidistant between the default bpp for two compression models (e.g., where the relative bit distance between the default bpp and the target bpp for two compression models is equal or substantially equal).

2) Improved betaDisplacementLog (BDL) Search for Selected Compression Model

A second improvement to the BRM method, which is independent of the first improvement concerning compression model selection, and which is also independent of the third improvement concerning beta evaluation, concerns determining the BDL to use for the selected compression model, i.e., searching for a trial rate control parameter.

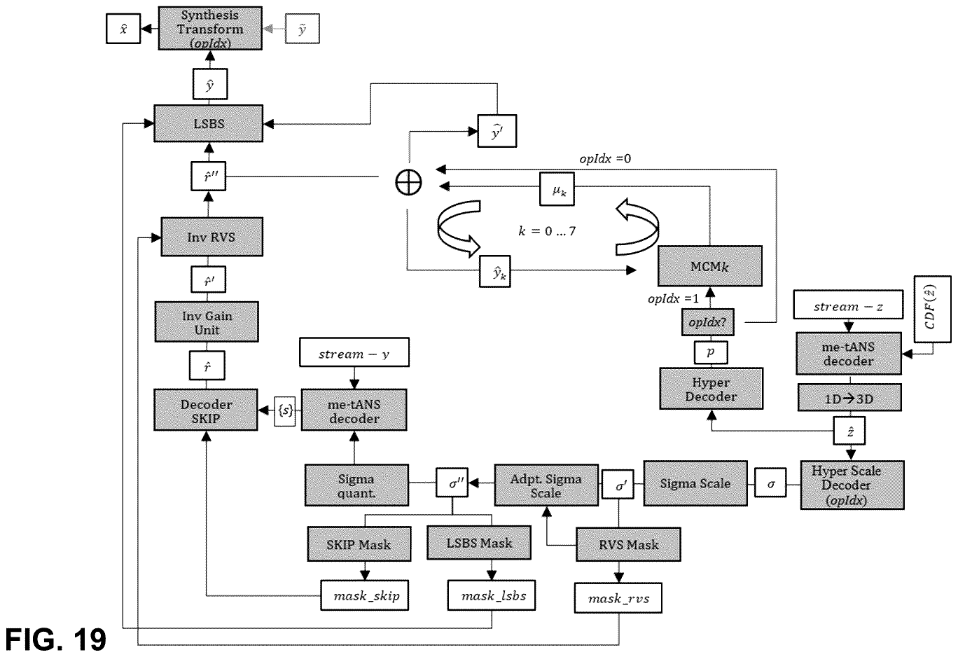

In known methods, a trial rate control parameter was search using a binary search. Given the maximum and minimum values of beta, a beta was searched for that generate a bpp that satisfies the bit rate difference tolerance, e.g., was sufficiently close to the target bitrate. This took time since many trial betas have to be tested, which involved using the trial beta to define a scaling of a gain vector (or gain tensor) which is applied to the latent space to obtain quantized latent space. The bpp could then be determined from the quantized bpp, specifically, by running the entropy model on the quantized latent space (the entropy model encoder, in the specific case of FIG. 19, being indicated by the “me-tANS” encoder, which is a lossless encoder and which produces the bitstream).

However, the inventors have established that a mathematical relationship exists between the input beta values (specifically, the rate control parameter, BDL) and the output of the resulting bitrate (bpp) generated by the compression model using the input BDL. In some examples, a linear or substantially linear relationship exists.

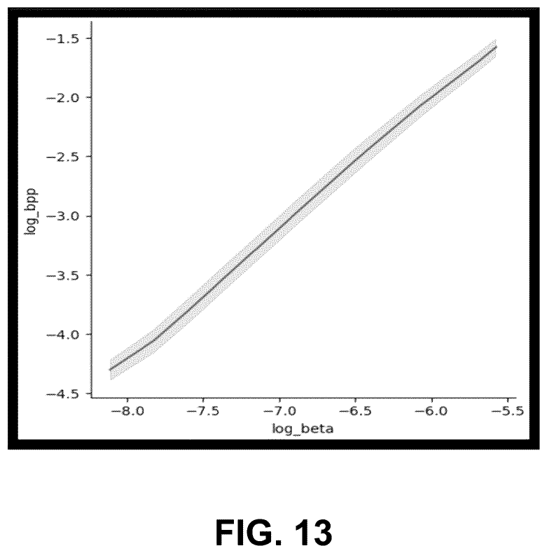

FIG. 13 shows an example of a such a linear relationship for a particular compression model. Here, the horizontal axis represents the input BDL values (i.e., betaDisplacementLog), and the vertical axis represents a logarithm of the output bpp values. It can be seen that the relationship between these two variables is substantially linear. Therefore, the inventors have established that, for a given trial value of BDL, a corresponding bpp can be determined. Therefore, an embodiment of the method involves determining a candidate/trial BDL value that would yield the target bpp value for that particular compression model. Once this trial BDL value is determined, it can be evaluated by the compression model to calculate the true bitrate (bpp value) generated by that combination of trial BDL value and compression model. If the true bitrate produced is equal to, or within a tolerance of, the target bitrate, that trial BDL value may be selected at the rate control parameter with which to quantize the latent space (i.e., by scaling the gain vector accordingly).

In detail, the linear relationship may be defined by using two points, where the first point is defined by the minimum beta value for that compression model with its associated output bitrate, and the second point is defined by the maximum beta value for that compression model with its associated output bitrate. Thus, the linear relationship may be calculated as follows:
Step 1: transform β_{displacement_log} range for a given compression model from the log domain into the linear domain, and obtain the corresponding min. and max. β_{displacement} values for the compression model.
Step 2: Calculate the βₘₐₓ and βₘᵢₙ by: β=β_{modelID}×β_{displacement}, based on the min. and max. β_{displacement} values for the compression model.
Step 3: Use βₘₐₓ to calculate bppₘₐₓ, and use βₘᵢₙ to get bppₘᵢₙ.
Step 4: Build a linear function, ƒ₁, using two points: (βₘₐₓ, bppₘₐₓ) and (βₘᵢₙ, bppₘᵢₙ).
Step 5: Calculate a trial beta, β_{now}, from ƒ₁ which is corresponding to bpp_{target}.

Other methods for generating such a linear function would also occur to the skilled person. Once the function, ƒ₁, is derived, step 5 indicates that a trial BDL value, β_{now}, is determined by using the ƒ₁ function. The trial BDL value is then evaluated using, for example, the improved evaluation method described below.

The inventors have further established that the ability to form a linear relationship as shown in FIG. 13 may be exploited as part of the evaluation process. The trial BDL value is evaluated after step 5 as follows:
Step 6: evaluate β_{now} and get the bpp_{now}, if bpp_{now} is close enough to bpp_{target}, return the corresponding β_{displacement_log} of β_{now}. Else, go to step 7

Thus, bpp_{now} represents the bitrate output when applying the trial rate control parameter value, β_{now}. Specifically, as mentioned earlier, the bpp is calculated by quantizing the latent representation of the image data using a gain vector or gain tensor that is scaled according to the beta value. The quantized latent representation is then entropy-encoded using a lossless entropy encoder to produce a bitstream, from which the bpp, bpp_{now}, can be determined. If this bpp value is not within a tolerance of the target bpp value, the linear relationship can be reformulated to obtain a more accurate linear relationship. The reformulated linear function is formed as follows:
Step 7: build a linear function ƒ₂ with 2 points: (βₘᵢₙ, bppₘᵢₙ) and β_{now}, bpp_{now}).

In other words, since the original linear function did not produce a bpp_{now}, the linear function can be updated using a pair of values, β_{now}, bpp_{now}, which are known to correspond in reality, i.e., they correspond because it has just been determined that β_{now} produces a bitrate of bpp_{now} when the compression model us applied using that beta value. Thus, the reformulated linear relationship is more likely to be able to predict a second trial beta value, β_{now2}, that will produce a bitrate (bpp) that is within a tolerance to the target bitrate. Nevertheless, it will be appreciated that steps 5, 6, and 7 can be iterated to re-build multiple linear functions until a beta value is found which produces a bitrate within a tolerance to the target bitrate, bpp_{target}.

Finally, the inventors have also established that, in some cases, an appropriate linear relationship may also be built in the linear domain as opposed to the logarithmic domain, i.e., where the variables forming the linear relationship represent linear values of beta and bpp.

In general, the inventors have further established that the asymmetric interval that may be used to ensure the absence of the performance drop from the desired envelope (e.g., when decoding a bitstream that may have been poorly encoded, for example) may also be applied when encoding. For example, instead of the usual maximum and minimum values of BDL (which, for a 12-bit value, may take the values of [−2048, 2047]) the searchable range of beta values may itself be clipped to reduce the searching burden. Thus, the searchable range of BDL values may be clipped in the same asymmetric fashion as described above, i.e., where the upper end of the range is clipped to a greater extent than the lower end of the range. 3) Improved evaluation of BDL value for selected compression model

The inventors have established that, in order to validate the value of beta chosen for the selected compression model, that beta is the only variable that affects the evaluation. In other words, during the beta searching, the only modification required is beta, since only beta influences the entropy of the resulting bitstream by scaling the latent space. Consequently, the improved presently-disclosed BRM method obviates the need to re-calculate the latent representation prior to each beta validation. Advantageously, once the compression model has been obtained, the latent representation can be determined and stored, after which point the latent representation need not be re-generated. Thus, the stored latent representation can simply be re-used to check the output bitrate (e.g., bpp) for different beta values under evaluation.

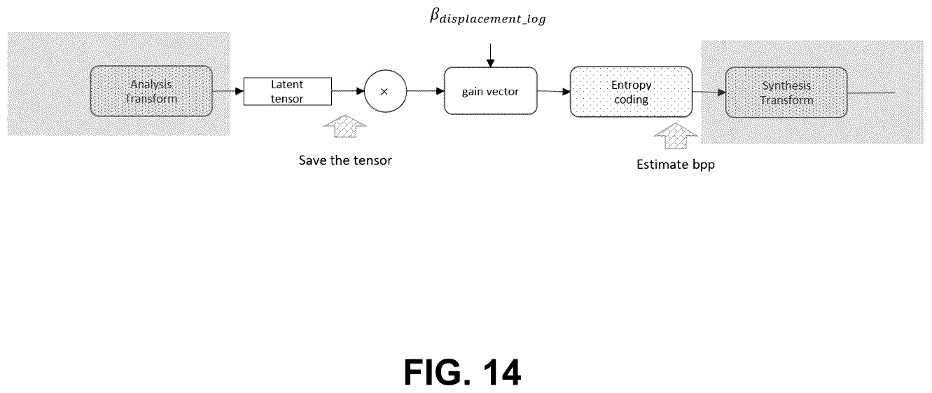

FIG. 14 illustrates this advantage. FIG. 14 illustrates that the analysis transform (i.e., the encoder) and the “synthesis transformer” (i.e., the decoder) need not be run for the beta evaluation. Instead, once the latent tensor (equivalent to the ‘latent representation’ or ‘latent space’ referred to in this disclosure) has been generated, it may be saved. During the evaluation of a beta, the trial BDL value is used as an input to scale a gain vector, which is applied to the latent tensor to form a quantised latent representation. The quantised latent representation may then be encoded using a lossless entropy encoder to obtain a bitstream, or a precursor bitstream. The bitstream can then be used to check/estimate the bpp, as indicated in FIG. 14. The advantage here is that, if the bpp produced from the trial BDL value is not within the tolerance and thus a new trial BDL value is searched for and evaluated, the evaluation process restarts using the same, already-stored, latent representation.

This improved evaluation method is significantly faster than known methods, since in previously known methods the evaluation required the entire codec to be re-run, specifically including the decoder, so that a loss could be calculated (where the loss calculation itself is a computationally expensive process). By contrast, the presently-disclosed method runs part of the codec once to get the latent tensor, and estimate the bpp by processing the latent tensor wherein the only modification/variable is the β_{displacement_log}, therefore the method avoids to run the entire codec for each iteration (i.e., each BDL value to be evaluated).

In summary, the inventors have established that the combination of all three of these improvements can yield a significant and surprising speedup of the encoding process. Compared to known methods which require the whole codec to run, and which potentially require multiple candidate compression models to be evaluated in tandem, the combination of three presently-disclosed improvements enables a speed a factor of about 3.7. In one experiment, it was determined that an encoding process according to the present method took 5.45 minutes compares to a prior art method which tool 20.3 minutes.

FIGS. 15A, 15B, and 15C will be described as being performed by a neural network system of one or more computers located in one or more locations. For example, a system configured to perform image compression, e.g., the neural network of FIG. 1 can perform the methods of 15A, 15B, and 15C.

FIG. 15A is a flow diagram illustrating an exemplary first method for encoding data for picture or video processing to obtain a bitstream, the method comprising. The embodiment according to FIG. 15A may be configured to provide output readily decoded by the decoding method described with reference to FIG. 10. The method comprises, at step 1500a, selecting a compression model in dependence on the target bitrate, e.g., based on the first improvement described above. Step 1502a comprises searching for a rate control parameter based on target bitrate, e.g., based on the second improvement described above. Step 1504a comprises obtaining a bitstream based on compression model and the selected control rate parameter. Thus, broadly speaking, the first exemplary embodiment confers the advantage of allowing the separation of i) selecting the compression model (modelidx) and ii) searching for beta. In known methods, these two parts of the encoding could not be separated, and as a result the method of encoding took substantially longer.

FIG. 15B is a flow diagram illustrating an exemplary second method for encoding data for picture or video processing to obtain a bitstream, the method comprising. The embodiment according to FIG. 15B may be configured to provide output readily decoded by the decoding method described with reference to FIG. 10. The method comprises, at step 1500b, obtaining a plurality of compression models and a target bitrate. Step 1502b comprises selecting a compression model in dependence on target bitrate, e.g., based on the first improvement described above. Step 1504b comprises obtaining a bitstream based on selected compression model. Generally speaking, this exemplary second method confers the advantage wherein selecting the compression model is determined based only on the relative bit distance, and need not involve calculating a loss, or using the decoder.

FIG. 15C is a flow diagram illustrating an exemplary third method for encoding data for picture or video processing to obtain a bitstream, the method comprising. The embodiment according to FIG. 15C may be configured to provide output readily decoded by the decoding method described with reference to FIG. 10. The method comprises, at step 1500c, obtaining a compression model and latent representation of image data, wherein the latent representation has been generated in dependence on the obtained compression model. Step 1502c comprises searching for a rate control parameter based on target bitrate, e.g., based on the second encoder improvement described above. Step 1504c comprises obtaining a bitstream based on the compression model and the selected rate control parameter. Generally speaking, this third exemplary embodiment confers the advantage that the beta can be determined without needing to re-calculate the latent tensor, and without needing to run the codec in general. In other words, once the compression model is chosen or obtained, the only further variable required to be searched to perform the encoding is the beta/BDL value. Advantageously, this means that the particular compression model and the latent tensor can be chosen or obtained entirely separately from the beta searching for the particular compression model.

FIG. 16A shows a device 200a for encoding for processing by a neural network based unit, based on method 15A. The device comprises an obtaining unit 210a configured to obtain:
image data defining at least a portion of an image;
a plurality of compression models, each respective compression model defined by a respective default rate control parameter having been used to train the compression model; and
a target bitrate indicating a degree of compression.

The device 200a comprises an encoding unit 212a configured to:
select a first compression model, from the plurality of compression models, in dependence on the target bitrate;
subsequent to selecting the first compression model:
   encode the image data, using an encoder, in dependence on the selected first compression model to thereby obtain a latent representation of the image data;
   search for a rate control parameter, the searching comprising:
      determining a trial rate control parameter, wherein the trial rate control parameter indicates a compression ratio;
      evaluating a suitability of the trial rate control parameter comprising calculating a trial bitrate in dependence on the latent representation and the trial rate control parameter; and
obtain a bitstream in dependence on the latent representation and a rate control parameter selected in dependence on the evaluating.

FIG. 16B shows a device 200b for encoding for processing by a neural network based unit, based on method 15B. The device comprises an obtaining unit 210b configured to obtain:
a plurality of compression models, each respective compression model defined by a respective default rate control parameter having been used to train the compression model;
image data defining at least a portion of an image; and
a target bitrate indicating a degree of compression;

The device 200b an encoding unit 212b configured to, for each compression model:
calculate a bitrate associated with the default rate control parameter having been used to train the compression mode;
determine a relative bit distance between the calculated bitrate and the target bitrate;
select a first compression model in dependence on at least one respective relative bit distance for at least one of the compression model; and
use the first compression model to obtain the bitstream from the image data.

FIG. 16C shows a device 200c for encoding for processing by a neural network based unit, based on method 15C. The device comprises an obtaining unit 210c configured to:
obtain and store a latent representation of image data defining at least a portion of an image, the latent representation having been produced in dependence on the image data and a compression model; and obtain a target bitrate indicating a degree of compression;

The device 200c an encoding unit 212c configured to:
subsequent to obtaining the latent representation, search for a rate control parameter to define a compression ratio, the searching comprising:
   determine a trial rate control parameter in dependence on the target bitrate; and
   evaluate a suitability of the trial rate control parameter comprising calculating a trial bitrate in dependence on the stored latent representation and the trial rate control parameter;
obtain a bitstream in dependence on the latent representation and the rate control parameter.

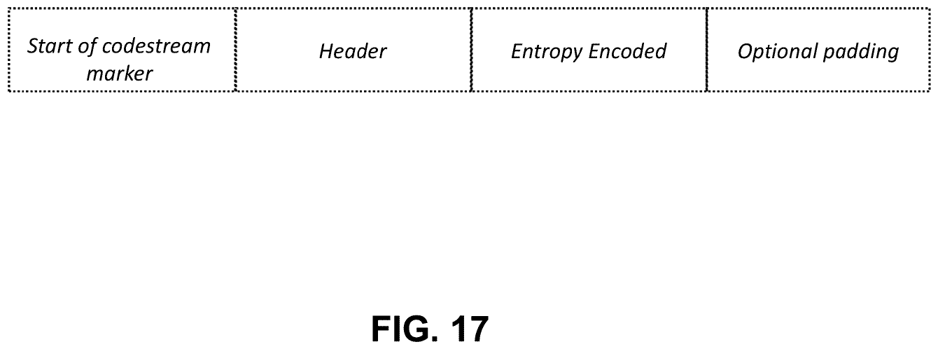

FIG. 17 illustrates one example of a bitstream (also called a ‘codestream’) that may be generated by a decoder, for example any of the presently-disclosed encoder methods such as one depicted in FIGS. 15A, 15B, and 15C, or any of the presently-disclosed decoder devices such as one depicted in FIGS. 16A, 16B, and 16C. The bitstream may comprise a marker indicating the start of the bitstream, header data including, for example, picture header data or tool header data, entropy-encoded data, and optionally padding which may include an end of code stream marker. In one particular embodiment, the bitstream may have the following structure:
1. SOC—Start Of Codestream marker;
2. PIH (Picture Header marker) followed by picture header;
3. TOH (Tools Header marker) followed by tools information;
4. SOZ (Start of Z-stream marker) followed codestream of hyper tensor z, including \hat{z} (“stream −z “in FIG. 19);
5. SORp (Start of primary component residual stream marker) followed by codestream of primary component residual, which includes \hat{r} (“stream y_{Y}” in FIG. 19);
6. SORp (Start of primary component secondary stream marker) followed by codestream of secondary component residual, which includes \hat{r} (“stream y” in FIG. 19);
7. EOC—End Of Codestream marker.

The overall syntax structure of an image is:

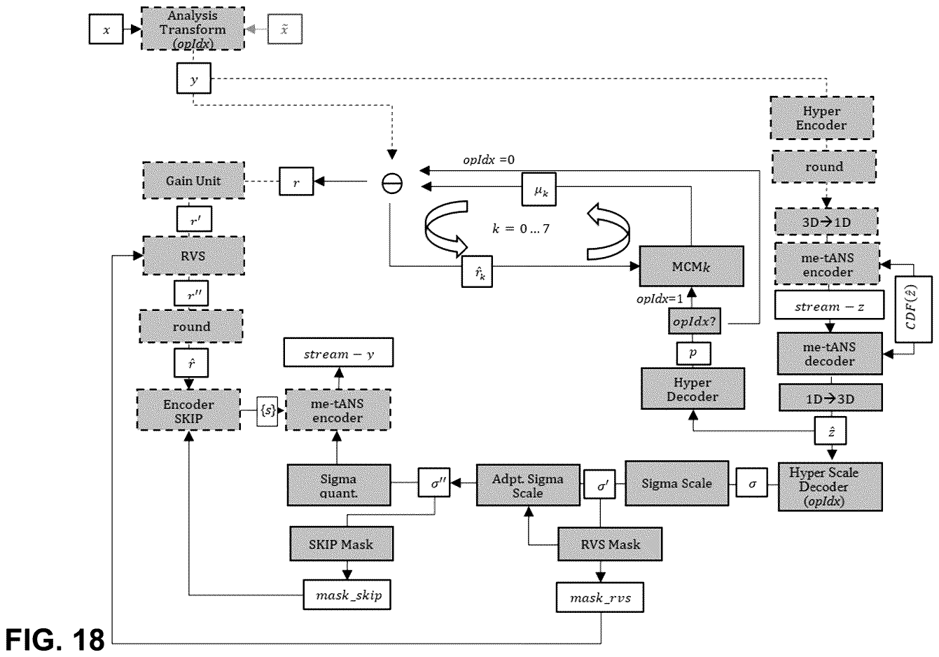

FIG. 18 depicts one particular example of an encoder according to presently-disclosed embodiments. In particular, this figure depicts the encoding process for a single component (e.g., either a Y or UV component of an image, representing luma and chroma respectively). The per component encoder is a multi-step process. The first step is analysis transform. Analysis transform receives two inputs x[Cᵢₙ,Hᵢₙ,Wᵢₙ]—the signal to be encoded and \tilde{x}[Cₑ,Hᵢₙ,Wᵢₙ]—auxiliary information to help encoding. Analysis transform outputs latent tensor y[C,h₄,w₄]. Depending on input picture height H and width W and scaling factors for primary (s_{Y}) and secondary (s_{UV}) components sizes of tensors are shown in Table 1. For primary component the parameter Cₑ=0, this means that primary component's Analysis transform receives no auxiliary information (encoded independently). For the secondary component the parameter Cₑ=1. For secondary component's Analysis transform the auxiliary information is tensor \tilde{x}_{Y}, which is re-sampled by factor s_{UV} primary component tensor x_{Y}.

The output of analysis transform goes to the Hyper Encoder. It generates hyper-parameters tensor z[C,h₆,w₆], which are rounded to \hat{z}, re-shaped to 1D array and encoded by loss-less coder (me-tANS encoder) forming stream z. The probability distribution for loss-less coding of \hat{z} is assumed to be Gaussian with pre-trained parameters (part of the trained model), Commulative Distribution Function (denoted as CDF(z)) computed based on those pre-trained parameters is used in loss-less entropy encoder (me-tANS encoder).

Then several steps identical to decoder operations (shown in FIG. 19) are performed on encoder side to produce entropy parameters for r encoding. 3D tensor r is converted to set of symbols {s} to be encoded inside Encoder SKIP module, values of r may be skipped for encoding.

FIG. 19 depicts one particular example of a decoder according to presently-disclosed embodiments. IN particular this figure depicts the decoding process for a single component (e.g., either a Y or UV component of an image, representing luma and chroma respectively). The codestream is composed from bit-streams stream z and stream y for primary and secondary components. For primary and secondary colour components code streams can be parsed independently and reconstructed using modules consisting of same sequence of same neural-network layers, with the only difference in sizes on input tensors and number of tensor channels. It is this separable decoding which is depicted in FIG. 19.

First, stream z shall be parsed by loss-less entropy decoder (me-tANS decoder). The probability distribution for loss-less coding of z is assumed to be Gaussian with pre-trained parameters (part of the trained model), Commulative Distribution Function (denoted on a FIG. 19 as CDF(\hat{z})) computed based on those pre-trained parameters is used in loss-less entropy decoder.

Decoded hyper-prior tensors \hat{z} is used as an input for two different processes: Hyper Decoder (section 11.2) and Hyper Scale Decoder (section 10.3).

Then stream y shall be parsed by loss-less decoder (me-tANS decoder). The probability distribution for parsing \hat{r} is assumed to be Gaussian with zero mean value and standard deviation given as an output if following steps: Hyper Scale Decoder outputs tensors of standard deviation in log-domain I_{σ}[C,h₄,w₄], then it is scaled according to the rate control parameter β inside Sigma Scale to produce as I′_{σ}, and then masked and scaled according to RVS parameters section inside Adaptive Sigma Scale producing I″_{σ}. Finally tensor I″_{σ} values are quantized (converted to the index of probability distribution table) in. Some elements of residual tensor may be skipped (not encoded/decoded) and replaced by zeros in Decoder SKIP module, which receives parsed set of syntax elements {s} from tANS Decoder (section 9.5), mask_sigma from SKIP Mask generation module and outputs re-shaped to 3D shape reconstructed residual tensor \hat{r}[C,h₄,w₄].

At the decoder side, the residual r is scaled by Inverse Gain Unit according to the parameter β, producing \hat{r}′. Then residual tensor is scaled in invRVS (Inverse Residual and Variance Scale) module (section 13.2.3) forming residual tensor \hat{r}″. This is used for reconstructed latent tensor ŷ. Hyper decoder generates explicit_prediction input to Multi-stage Context Model—MCM, which is eight stages neural network process, which also takes reconstructed residual \hat{r}″ as an input and outputs latent space tensors ŷ′. After Latent Scaling Before Synthesis-LSBS reconstructed latent space tensor ŷ is ready for signal reconstruction. Latent tensors reconstructions for primary and secondary components are independent from each other.

In the context of FIGS. 18 and 19, it is noted that the rate control parameter, β controls compression ratio and defines operations in each of the Gain Unit, Sigma Scale, and the Inverse Gain Units shown in these figures. The forward gain tensor m is used at encoder side in Gain Unit. Forward gain tensor in logarithmic scale m_{log} is used in Sigma scale. The inverse gain tensor m⁻¹ is used at decoder side in Inverse Gain Unit. All three forward m, inverse m⁻¹ and logarithmic domain m_{log} gain tensors have size[C,h₄,w₄] equal to the size of residual tensor.

### Loss Functions

The loss function used to determine the loss of the decoded image produced by some embodiments of the method described above (e.g., in FIG. 12B) may include a plurality of items. For an image encoding task, loss items related to reconstruction quality generally include a L1 loss, a L2 loss (or referred to as an MSE loss), an MS-SSIM loss, a VGG loss, an LPIPS loss, a GAN loss, and the like, and further include loss items related to bitstream size.

The L1 loss calculates an average value of errors between points to obtain a L1 loss value. The L1 loss function can better evaluate reconstruction quality of a structured region in an image.

Mean squared error (mean squared error, MSE) loss: a function for measuring a distance between two pieces of data. In this embodiment of this application, the MSE loss is also referred to as the L2 loss function. An average value of squares of errors between points is calculated to obtain an L2 loss value. The MSE loss may also be used to calculate a PSNR. The L2 loss is also a pixel-level loss. The L2 loss function can also better evaluate reconstruction quality of a structured region in an image. If the L2 loss function is used to optimize an image encoding and decoding network, an optimized image encoding and decoding network can achieve a higher PSNR.

Structural similarity index measure (structural similarity index measure, SSIM): an objective criterion for evaluating image quality. Higher SSIM indicates better image quality. In this embodiment of this application, structural similarity between two images at a scale is calculated to obtain an SSIM loss value. The SSIM loss is a loss based on an artificial feature. Compared with the L1 loss function and the L2 loss function, the SSIM loss function can more objectively evaluate image reconstruction quality, that is, evaluate a structured region and an unstructured region of an image in a more balanced manner. If the SSIM loss function is used to optimize an image encoding and decoding network, an optimized image encoding and decoding network can achieve a higher SSIM.

Multi-scale structural similarity index measure (multi-scale SSIM, MS-SSIM): an objective criterion for evaluating image quality. Higher SSIM indicates better image quality. Multi-layer low-pass filtering and downsampling are separately performed on two images to obtain image pairs at a plurality of scales. A contrast map and structure information are extracted from an image pair at each scale, and SSIM loss values at the corresponding scale are obtained based on the contrast map and the structure information. Luminance information of an image pair at a smallest scale is extracted, and a luminance loss value at the smallest scale is obtained based on the luminance information. Then, the SSIM loss values and the luminance loss value at the plurality of scales are aggregated in a manner to obtain an MS-SSIM loss value, for example, an aggregation manner in Equation (1):

$$MS - SSIM ( x , y ) = {[ {l}_{M} ( x , y ) ]}^{{a}_{M}} * {\prod }_{j = 1}^{M} {{[ {c}_{j} ( x , y ) ]}^{{β}_{j}} [ {s}_{j} ( x , y ) ]}^{{r}_{j}} \qquad ( 1 )$$

In Equation (1), the loss values at all the scales are aggregated in a manner of exponential power weighting and multiplication. Herein, x and y separately indicate the two images, l indicates the loss value based on the luminance information, c indicates the loss value based on the contrast map, and s indicates the loss value based on the structure information. A subscript j=1, . . . , M indicates M scales that separately correspond to total M times of downsampling, j=1 indicates a largest scale, and j=M indicates the smallest scale. The superscripts α, β, and γ each indicate an exponential power of a corresponding term.

The MS-SSIM loss function and the SSIM loss function have similar better image evaluation effect. Compared with the L1 loss and the L2 loss, the MS-SSIM loss for optimization can improve subjective experience of human eyes and meet objective evaluation indicators. If the MS-SSIM loss function is used to optimize an image encoding and decoding network, an optimized image encoding and decoding network can achieve a higher MS-SSIM.

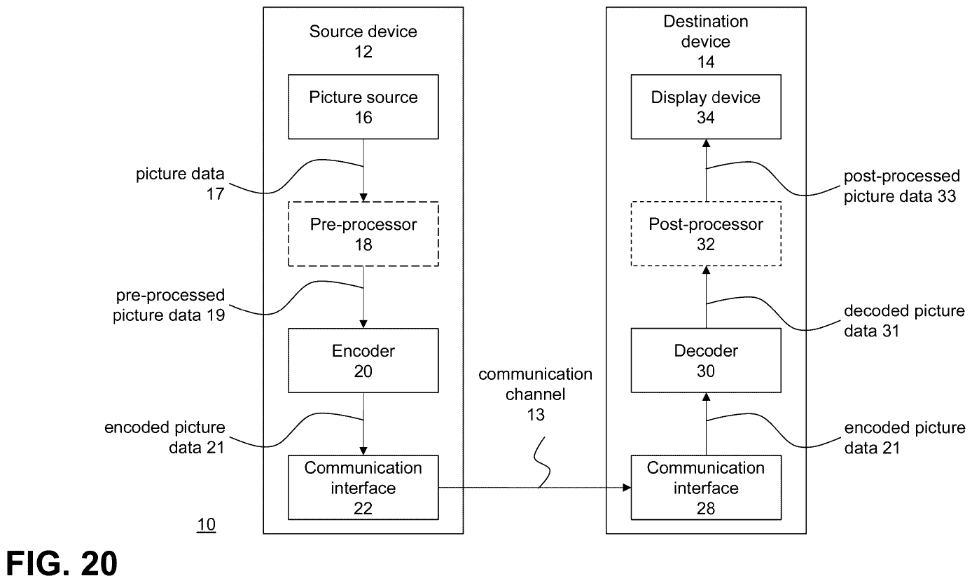

The corresponding system Ih may″Il′y the above-mentioned encoder-decoder processing chain is illustrated in FIG. 20. FIG. 20 is a schematic block diagram illustrating an example coding system, e.g. a video, image, audio, and/or other coding system (or short coding system) that may utilize techniques of this present application. Video encoder 20 (or short encoder 20) and video decoder 30 (or short decoder 30) of video coding system 10 represent examples of devices that may be configured to perform techniques in accordance with various examples described in the present application. For example, the video coding and decoding may employ neural network such which may be distributed and which may apply the above-mentioned bitstream parsing and/or bitstream generation to convey feature maps between the distributed computation nodes (two or more).

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

As shown in FIG. 20, the coding system 10 comprises a source device 12 configured to provide encoded picture data 21 e.g. to a destination device 14 for decoding the encoded picture data 13.

The source device 12 comprises an encoder 20, and may additionally, i.e. optionally, comprise a picture source 16, a pre-processor (or pre-processing unit) 18, e.g. a picture pre-processor 18, and a communication interface or communication unit 22.

The picture source 16 may comprise or be any kind of picture capturing device, for example a camera for capturing a real-world picture, and/or any kind of a picture generating device, for example a computer-graphics processor for generating a computer animated picture, or any kind of other device for obtaining and/or providing a real-world picture, a computer generated picture (e.g. a screen content, a virtual reality (VR) picture) and/or any combination thereof (e.g. an augmented reality (AR) picture). The picture source may be any kind of memory or storage storing any of the aforementioned pictures.

In distinction to the pre-processor 18 and the processing performed by the pre-processing unit 18, the picture or picture data 17 may also be referred to as raw picture or raw picture data 17.

Pre-processor 18 is configured to receive the (raw) picture data 17 and to perform pre-processing on the picture data 17 to obtain a pre-processed picture 19 or pre-processed picture data 19. Pre-processing performed by the pre-processor 18 may, e.g., comprise trimming, color format conversion (e.g. from RGB to YcbCr), color correction, or de-noising. It can be understood that the pre-processing unit 18 may be optional component. It is noted that the pre-processing may also employ a neural network (such as in any of FIGS. 1 to 7) which uses the presence indicator signaling.

The video encoder 20 is configured to receive the pre-processed picture data 19 and provide encoded picture data 21.

Communication interface 22 of the source device 12 may be configured to receive the encoded picture data 21 and to transmit the encoded picture data 21 (or any further processed version thereof) over communication channel 13 to another device, e.g. the destination device 14 or any other device, for storage or direct reconstruction.

The destination device 14 comprises a decoder 30 (e.g. a video decoder 30), and may additionally, i.e. optionally, comprise a communication interface or communication unit 28, a post-processor 32 (or post-processing unit 32) and a display device 34.

The communication interface 28 of the destination device 14 is configured receive the encoded picture data 21 (or any further processed version thereof), e.g. directly from the source device 12 or from any other source, e.g. a storage device, e.g. an encoded picture data storage device, and provide the encoded picture data 21 to the decoder 30.

The communication interface 22 and the communication interface 28 may be configured to transmit or receive the encoded picture data 21 or encoded data 13 via a direct communication link between the source device 12 and the destination device 14, e.g. a direct wired or wireless connection, or via any kind of network, e.g. a wired or wireless network or any combination thereof, or any kind of private and public network, or any kind of combination thereof.

The communication interface 22 may be, e.g., configured to package the encoded picture data 21 into an appropriate format, e.g. packets, and/or process the encoded picture data using any kind of transmission encoding or processing for transmission over a communication link or communication network.

The communication interface 28, forming the counterpart of the communication interface 22, may be, e.g., configured to receive the transmitted data and process the transmission data using any kind of corresponding transmission decoding or processing and/or de-packaging to obtain the encoded picture data 21.

Both, communication interface 22 and communication interface 28 may be configured as unidirectional communication interfaces as indicated by the arrow for the communication channel 13 in FIG. 20 pointing from the source device 12 to the destination device 14, or bi-directional communication interfaces, and may be configured, e.g. to send and receive messages, e.g. to set up a connection, to acknowledge and exchange any other information related to the communication link and/or data transmission, e.g. encoded picture data transmission. The decoder 30 is configured to receive the encoded picture data 21 and provide decoded picture data 31 or a decoded picture 31.

The post-processor 32 of destination device 14 is configured to post-process the decoded picture data 31 (also called reconstructed picture data), e.g. the decoded picture 31, to obtain post-processed picture data 33, e.g. a post-processed picture 33. The post-processing performed by the post-processing unit 32 may comprise, e.g. color format conversion (e.g. from YcbCr to RGB), color correction, trimming, or re-sampling, or any other processing, e.g. for preparing the decoded picture data 31 for display, e.g. by display device 34.

The display device 34 of the destination device 14 is configured to receive the post-processed picture data 33 for displaying the picture, e.g. to a user or viewer. The display device 34 may be or comprise any kind of display for representing the reconstructed picture, e.g. an integrated or external display or monitor. The displays may, e.g. comprise liquid crystal displays (LCD), organic light emitting diodes (OLED) displays, plasma displays, projectors, micro LED displays, liquid crystal on silicon (LcoS), digital light processor (DLP) or any kind of other display.

Although FIG. 20 depicts the source device 12 and the destination device 14 as separate devices, embodiments of devices may also comprise both or both functionalities, the source device 12 or corresponding functionality and the destination device 14 or corresponding functionality. In such embodiments the source device 12 or corresponding functionality and the destination device 14 or corresponding functionality may be implemented using the same hardware and/or software or by separate hardware and/or software or any combination thereof.

As will be apparent for the skilled person based on the description, the existence and (exact) split of functionalities of the different units or functionalities within the source device 12 and/or destination device 14 as shown in FIG. 20 may vary depending on the actual device and application.

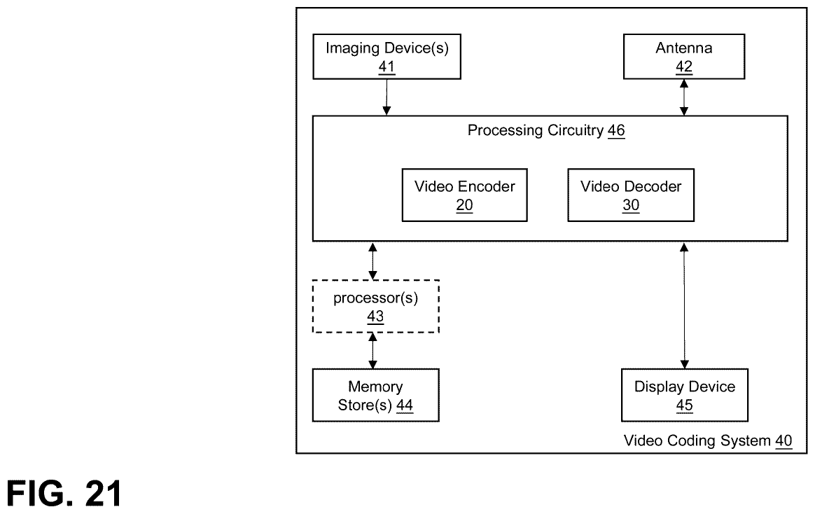

The encoder 20 (e.g. a video encoder 20) or the decoder 30 (e.g. a video decoder 30) or both encoder 20 and decoder 30 may be implemented via processing circuitry, such as one or more microprocessors, digital signal processors (DSPs), application-specific integrated circuits (ASICs), field-programmable gate arrays (FPGAs), discrete logic, hardware, video coding dedicated or any combinations thereof. The encoder 20 may be implemented via processing circuitry 46 to embody the various modules including the neural network or its parts. The decoder 30 may be implemented via processing circuitry 46 to embody any coding system or subsystem described herein. The processing circuitry may be configured to perform the various operations as discussed later. If the techniques are implemented partially in software, a device may store instructions for the software in a suitable, non-transitory computer-readable storage medium and may execute the instructions in hardware using one or more processors to perform the techniques of this disclosure. Either of video encoder 20 and video decoder 30 may be integrated as part of a combined encoder/decoder (CODEC) in a single device, for example, as shown in FIG. 21.

Source device 12 and destination device 14 may comprise any of a wide range of devices, including any kind of handheld or stationary devices, e.g. notebook or laptop computers, mobile phones, smart phones, tablets or tablet computers, cameras, desktop computers, set-top boxes, televisions, display devices, digital media players, video gaming consoles, video streaming devices(such as content services servers or content delivery servers), broadcast receiver device, broadcast transmitter device, or the like and may use no or any kind of operating system. In some cases, the source device 12 and the destination device 14 may be equipped for wireless communication. Thus, the source device 12 and the destination device 14 may be wireless communication devices.

In some cases, video coding system 10 illustrated in FIG. 20 is merely an example and the techniques of the present application may apply to video coding settings (e.g., video encoding or video decoding) that do not necessarily include any data communication between the encoding and decoding devices. In other examples, data is retrieved from a local memory, streamed over a network, or the like. A video encoding device may encode and store data to memory, and/or a video decoding device may retrieve and decode data from memory. In some examples, the encoding and decoding is performed by devices that do not communicate with one another, but simply encode data to memory and/or retrieve and decode data from memory.

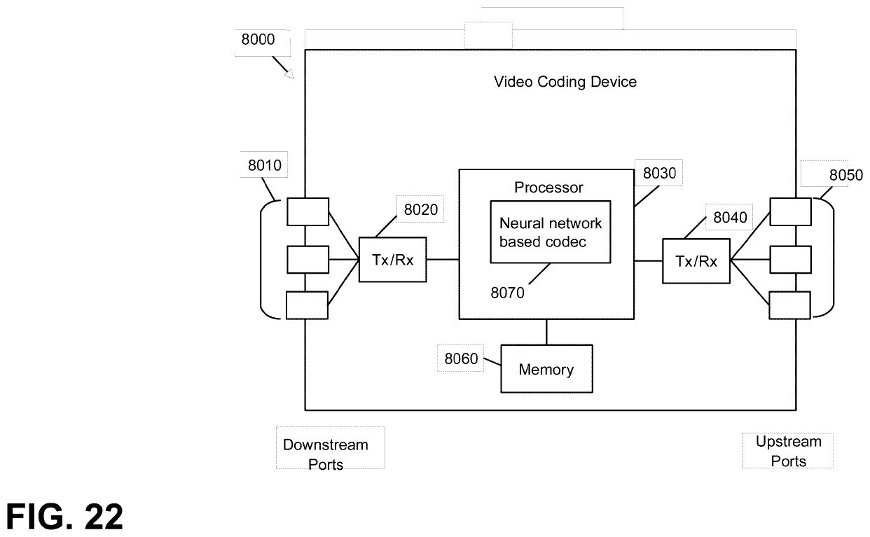

FIG. 22 is a schematic diagram of a video coding device 8000 according to an embodiment of the disclosure. The video coding device 8000 is suitable for implementing the disclosed embodiments as described herein. In an embodiment, the video coding device 8000 may be a decoder such as video decoder 30 of FIG. 20 or an encoder such as video encoder 20 of FIG. 20.

The video coding device 8000 comprises ingress ports 8010 (or input ports 8010) and receiver units (Rx) 8020 for receiving data; a processor, logic unit, or central processing unit (CPU) 8030 to process the data; transmitter units (Tx) 8040 and egress ports 8050 (or output ports 8050) for transmitting the data; and a memory 8060 for storing the data. The video coding device 8000 may also comprise optical-to-electrical (OE) components and electrical-to-optical (EO) components coupled to the ingress ports 8010, the receiver units 8020, the transmitter units 8040, and the egress ports 8050 for egress or ingress of optical or electrical signals.

The processor 8030 is implemented by hardware and software. The processor 8030 may be implemented as one or more CPU chips, cores (e.g., as a multi-core processor), FPGAs, ASICs, and DSPs. The processor 8030 is in communication with the ingress ports 8010, receiver units 8020, transmitter units 8040, egress ports 8050, and memory 8060. The processor 8030 comprises a neural network based codec 8070. The neural network based codec 8070 implements the disclosed embodiments described above. For instance, the neural network based codec 8070 implements, processes, prepares, or provides the various coding operations. The inclusion of the neural network based codec 8070 therefore provides a substantial improvement to the functionality of the video coding device 8000 and effects a transformation of the video coding device 8000 to a different state. Alternatively, the neural network based codec 8070 is implemented as instructions stored in the memory 8060 and executed by the processor 8030.

The memory 8060 may comprise one or more disks, tape drives, and solid-state drives and may be used as an over-flow data storage device, to store programs when such programs are selected for execution, and to store instructions and data that are read during program execution. The memory 8060 may be, for example, volatile and/or non-volatile and may be a read-only memory (ROM), random access memory (RAM), ternary content-addressable memory (TCAM), and/or static random-access memory (SRAM).

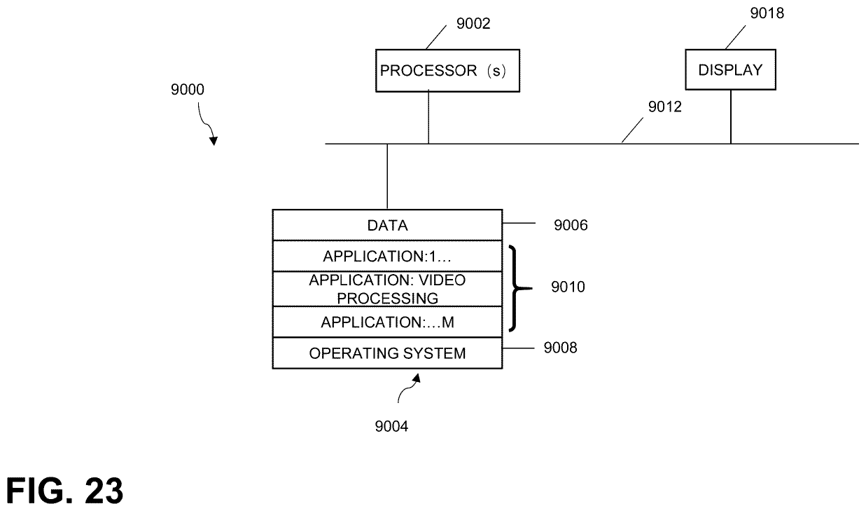

FIG. 23 is a simplified block diagram of an apparatus that may be used as either or both of the source device 12 and the destination device 14 from FIG. 20 according to an exemplary embodiment.

A processor 9002 in the apparatus 9000 can be a central processing unit. Alternatively, the processor 9002 can be any other type of device, or multiple devices, capable of manipulating or processing information now-existing or hereafter developed. Although the disclosed implementations can be practiced with a single processor as shown, e.g., the processor 9002, advantages in speed and efficiency can be achieved using more than one processor.

A memory 9004 in the apparatus 9000 can be a read only memory (ROM) device or a random access memory (RAM) device in an implementation. Any other suitable type of storage device can be used as the memory 9004. The memory 9004 can include code and data 9006 that is accessed by the processor 9002 using a bus 9012. The memory 9004 can further include an operating system 9008 and application programs 9010, the application programs 9010 including at least one program that permits the processor 9002 to perform the methods described here. For example, the application programs 9010 can include applications 1 through N, which further include a video coding application that performs the methods described here.

The apparatus 9000 can also include one or more output devices, such as a display 9018. The display 9018 may be, in one example, a touch sensitive display that combines a display with a touch sensitive element that is operable to sense touch inputs. The display 9018 can be coupled to the processor 9002 via the bus 9012.

Although depicted here as a single bus, the bus 9012 of the apparatus 9000 can be composed of multiple buses. Further, a secondary storage can be directly coupled to the other components of the apparatus 9000 or can be accessed via a network and can comprise a single integrated unit such as a memory card or multiple units such as multiple memory cards. The apparatus 9000 can thus be implemented in a wide variety of configurations.

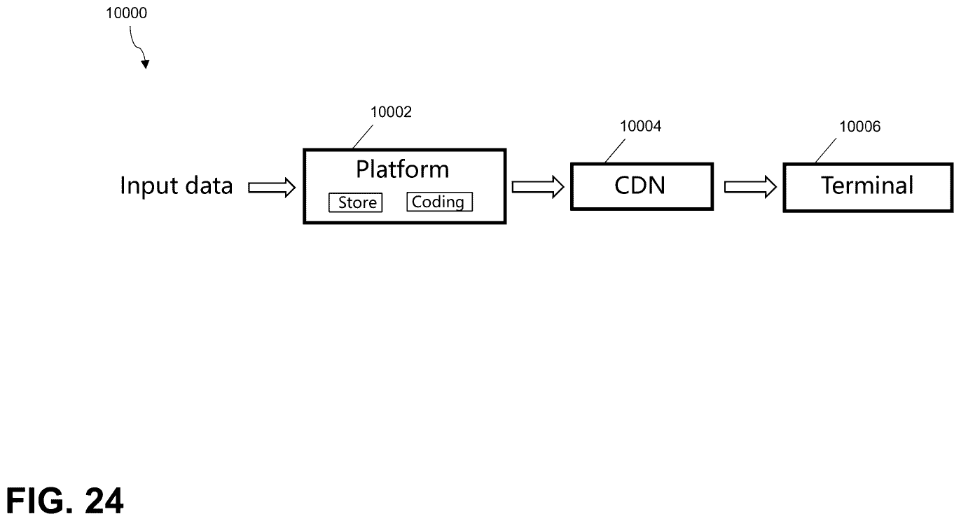

FIG. 24 is a block diagram of a video coding system 10000 according to an embodiment of the disclosure.

A platform 10002 in the system 10000 may be a cloud sever or local sever. Alternatively, the platform 10002 can be any other type of device, or multiple devices, capable of calculation, storing, transcoding, encryption, rendering, decoding or encoding. Although the disclosed implementations can be practiced with a single platform as shown, e.g., the platform 10002, advantages in speed and efficiency can be achieved using more than one platform.

A content delivery network (CDN) 10004 in the system 10000 can be a group of geographically distributed servers. Alternatively, the CDN 10004 can be any other type of device, or multiple devices, capable of data buffering, scheduling, dissemination or speed up the delivery of web content by bringing it closer to where users are. Although the disclosed implementations can be practiced with a single CDN as shown, e.g., the CDN 10004, advantages in speed and efficiency can be achieved using more than one CDN.

A terminal 10006 in the apparatus 10000 can be a mobile phone, computer, television, laptop, camera. Alternatively, the terminal 10006 can be any other type of device, or multiple devices, capable of displaying video or image.

1. A method for decoding data corresponding to a picture or at least one video frame from a bitstream, the method comprising:
obtaining, from the bitstream, a rate control parameter having been used to encode the data for picture or video by an encoder model, wherein the rate control parameter that indicates a compression ratio, wherein the data corresponding to the picture or the at least one video frame has been encoded in the bitstream by an encoder model using the rate control parameter;
obtaining an asymmetric interval defined by an upper rate control threshold and a lower rate control threshold;
clipping, based on a value of the rate control parameter lying outside of a range of the asymmetric interval, the rate control parameter to obtain a clipped rate control parameter, the clipping comprising:
if the value of the rate control parameter is greater than the upper rate control threshold, setting the clipped rate control parameter equal to the upper rate control threshold; and
if the value of the rate control parameter is smaller than the lower rate control threshold, setting the clipped rate control parameter equal to the lower rate control threshold,
wherein a first magnitude defined by a difference between a largest representable value of the rate control parameter and the upper rate control threshold is greater than a second magnitude defined by a difference between a smallest representable value of the rate control parameter and the lower rate control threshold.

2. The method as claimed in claim 1, wherein the rate control parameter defines a quantization step for a latent space encoded in the bitstream.

3. The method as claimed in claim 1, wherein each of the upper rate control threshold and the lower rate control threshold are pre-determined based on a deviation tolerance, wherein the deviation tolerance is defined, for each of the upper and lower rate control thresholds, by a numerical deviation between:
i) a model performance envelope defined by a model used to train the encoder model, and
ii) an encoder performance obtained as a result of encoding using each respective upper rate control threshold and the lower rate control threshold.

4. The method of claim 3, wherein the numerical deviation is calculated in dependence on a difference between a target bitrate value and a target compression quality value of the model performance envelope.

5. The method as claimed in claim 1, wherein the rate control parameter defines a ratio between a compression quantization parameter selected by the encoder model and a training compression quantization parameter used to train a compression model used by the encoder model.

6. The method as claimed in claim 1, wherein a bit-depth of the rate control parameter is n, wherein the largest representable value of the rate control parameter is 2ⁿ⁻¹, and wherein the smallest representable value of the rate control parameter is 2ⁿ⁻¹, wherein a magnitude of the lower rate control threshold is greater than a magnitude of the upper rate control threshold.

7. The method as claimed in claim 6, wherein the bit-depth of the rate control parameter is n=12, and wherein the asymmetric interval is [−1069, 702].

8. The method as claimed in claim 1, wherein a bit-depth of the rate control parameter is n, wherein the largest representable value of the rate control parameter is 2ⁿ⁻¹, and wherein the smallest representable value of the rate control parameter is 0, the method further comprising:
prior to determining that the value of the rate control parameter lies outside of a range of the asymmetric interval:
shifting the rate control parameter by an offset, wherein a magnitude of the offset is greater than 2ⁿ⁻¹, wherein the upper rate control threshold is defined by a 2ⁿ−1-offset, and the lower rate control threshold is defined by a 0-offset.

9. The method of claim 8, wherein n<17.

10. The method of claim 8, further comprising reducing a value of the upper rate control threshold, defined by the 2ₙ−1-offset, to increase a bias of the asymmetric interval towards a negative portion of the asymmetric interval.

11. The method as claimed in claim 1, wherein the encoder model is a neural network-based image codec having a variable rate, wherein the rate control parameter is a continuously variable parameter.

12. The method as claimed in claim 1, wherein the clipped rate control parameter is used to define a set of data defining a gain to be applied to a latent representation of encoded data.

13. The method as claimed in claim 1, wherein decoding the data corresponding to the picture or at the least one video frame from the bitstream comprises performing the steps of claim 1 a second time for a second rate control parameter and a second asymmetric interval, wherein the first rate control parameter and second rate control parameter correspond to two separable components representing the data corresponding to the picture or the at least one video frame.

14. The method as claimed in claim 1, wherein the rate control parameter is defined in a logarithmic domain.

15. A device for decoding data corresponding to a picture or at least one video frame from a bitstream, the device comprising:
processing circuitry configured to:
obtain, from the bitstream, a rate control parameter that indicates a compression ratio, wherein the data corresponding to the picture or the at least one video frame has been encoded in the bitstream by an encoder model using the rate control parameter,
obtain an asymmetric interval defined by an upper rate control threshold and a lower rate control threshold,
clip, based on a value of the rate control parameter lying outside of a range of the asymmetric interval, the rate control parameter to obtain a clipped rate control parameter, the clipping comprising:
if the value of the rate control parameter is greater than the upper rate control threshold, setting the clipped rate control parameter equal to the upper rate control threshold; and
if the value of the rate control parameter is smaller than the lower rate control threshold, setting the clipped rate control parameter equal to the lower rate control threshold,
wherein a first magnitude defined by i) a difference between a largest representable value of the rate control parameter and the upper rate control threshold is greater than a second magnitude defined by ii) a difference between a smallest representable value of the rate control parameter and the lower rate control threshold.

16. The method as claimed in claim 1, wherein the bitrate defines an effective number of bits per pixel.

17. The method as claimed in claim 1, wherein the encoder model comprises a neural network.

18. A non-transitory computer readable medium and including code instructions, which, when executed on one or more processors, cause the one or more processors to execute a method for decoding data for picture or video processing from a bitstream, the method comprising:
obtaining, from the bitstream, a rate control parameter that indicates a compression ratio, wherein the data corresponding to the picture or the at least one video frame has been encoded in the bitstream by an encoder model using the rate control parameter;
obtaining an asymmetric interval defined by an upper rate control threshold and a lower rate control threshold;
clipping, based on a the value of the rate control parameter lying outside of a range of the asymmetric interval, the rate control parameter to obtain a clipped rate control parameter, the clipping comprising:
if the value of the rate control parameter is greater than the upper rate control threshold, setting the clipped rate control parameter equal to the upper rate control threshold; and
if the value of the rate control parameter is smaller than the lower rate control threshold, setting the clipped rate control parameter equal to the lower rate control threshold, wherein a first magnitude defined by a difference between a largest representable value of the rate control parameter and the upper rate control threshold is greater than a second magnitude defined by a difference between a smallest representable value of the rate control parameter and the lower rate control threshold.
